(19) United States
(12) Patent Application Publication
(10) Pub. No.: US 2006/0238738 A1
(43) Pub. Date: Oct. 26, 2006

(54) Projecting exposure apparatus

(75) Inventors: Hiromi Ishikawa, Kanagawa-ken (JP); Sumihiro Nishihata, Kanagawa-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/447,062

(22) Filed: Jun. 6, 2006

Related U.S. Application Data
(62) Division of application No. 10/835,421, filed on Apr. 30, 2004, now abandoned.

(30) Foreign Application Priority Data
May 6, 2003 (JP) 2003-127892

(51) Int. Cl. G03B 27/54

(52) U.S. Cl. 355/67; 355/53

(57) ABSTRACT

A spatial light modulator performs spatial light modulation of light produced by a light source. An image-side telecentric image foaming optical system forms an image of a two-dimensional pattern of the light, which has been obtained from the spatial lightmodulation performed by the spatial light modulator, on a photosensitive material. At least either one of two pupil-adjacent lenses, which are adjacent to each other with an entrance pupil position in the image forming optical system intervening between the two pupil-adjacent lenses, is constituted such that at least either one of lens surfaces of the pupil-adjacent lens is an aspherical surface.

### BACKGROUND OF THE INVENTION

This is a divisional of Application Ser. No. 10/835,421 filed Apr. 30, 2004. The entire disclosure of the prior application number 10/835,421 is considered part of the disclosure of the accompanying divisional application and is hereby incorporated by reference.

### FIELD OF THE INVENTION

This invention relates to a projecting exposure apparatus. This invention particularly relates to a projecting exposure apparatus, wherein light having been produced by a light source is modulated, an image of a two-dimensional pattern of the light having been obtained from the light modulation is projected through a telecentric image forming optical system onto a photosensitive material, and the photosensitive material is thus exposed to the image of the two-dimensional pattern of the light.

### Description of the Related Art

Projecting exposure apparatuses, wherein a two-dimensional pattern of light, which has been obtained from modulation of incident light performed by an exposure mask, or a two-dimensional pattern of light, which has been obtained from spatial light modulation of incident light performed by spatial light modulation means, is projected onto a photosensitive material, and the photosensitive material is thus exposed to the two-dimensional pattern of the light, have heretofore been known. Also, projecting exposure apparatuses, wherein a digital micromirror device (hereinbelow referred to as the DMD) comprising a plurality of (e. g., 1,024×756) micromirrors, which allow alteration of their inclination angles and which are arrayed in a two-dimensional pattern, is utilized as the spatial light modulation means, have heretofore been known. (The projecting exposure apparatuses, wherein the digital micromirror device (DMD) is utilized as the spatial light modulation means, are described in, for example, Patent Literature 1.) As the digital micromirror device (DMD), for example, a DMD supplied by Texas Instruments Co. has been known. Projectors for dynamic images, wherein the DMD is utilized, and the like, have been used in practice.

The projecting exposure apparatuses utilizing the DMD are provided with an image forming lens for forming an image of each of the micromirrors of the DMD on the photosensitive material. With the projecting exposure apparatuses utilizing the DMD, the images of only the light, which has been reflected from certain micromirrors inclined at predetermined angles among the micromirrors that receive the irradiated light for exposure, and which travels toward the image forming lens, are formed through the image forming lens. In this manner, the two-dimensional pattern having been formed by the micromirrors is projected onto the photosensitive material, and the photosensitive material is thus exposed to the two-dimensional pattern. Specifically, with the projecting exposure apparatuses utilizing the DMD, the exposure operation is performed such that each of pixels constituting the image of the two-dimensional pattern corresponds to one of the micromirrors.

Also, attempts have heretofore been made to exposing a photoresist (a photosensitive material), which has been formed on a board, to a circuit pattern by use of the projecting exposure apparatuses described above. Further, it has been considered to employ a technique, wherein an image forming optical system, which is telecentric on the image side, is utilized as the image forming optical system of the projecting exposure apparatuses, such that the image of the circuit pattern is capable of being formed on the board with accurate magnification, i.e. with quality free from variation in size of the image of the circuit pattern and distortion of the image.

[Patent Literature 1]
Japanese Unexamined Patent Publication No. 2001-305663

However, as for the exposure operation for the circuit pattern described above, it is desired that equi-pitch characteristics of the pixels constituting the image of the circuit pattern, to which the board is to be exposed, be enhanced even further. In order for the equi-pitch characteristics of the pixels constituting the image of the circuit pattern to be enhanced even further, there are strong demands for suppression of a distortion of an image forming lens to as small as at most 1 μm and for enhancement of modulation transfer function (MTF) performance. Specifically, there are strong demands for suppression of the distortion and enhancement of the MTF performance.

Also, in cases where the exposure operation is to be performed for a pattern of thin lines, such as the circuit pattern, it is desired that a light source for producing light having short wavelengths, e.g. wavelengths of at most 450 nm, be utilized. However, the light having the short wavelengths has low capability of passing through the material constituting the image forming lens described above, such as glass or a resin. Therefore, it is desired that the number of lenses constituting the image forming lens is set to be small, and the light utilization efficiency is thereby enhanced. Specifically, for example, in cases where a laser beam combining light source for combining a plurality of laser beams with one another is utilized as the exposure light source, if the light utilization efficiency is enhanced, a predetermined laser beam intensity necessary for the exposure operation will be capable of being obtained from a comparatively small number of the laser beams, which are combined with one another. In such cases, the cost of the exposure light source will be capable of being kept low, and the frequency of occurrence of failures of the light source will be capable of being kept low.

Further, in cases where the number of the lenses constituting the image forming lens is set to be large, the distortion and curvature of field become large due to accumulation of errors in production of each of the lenses constituting the image forming lens. Therefore, the problems occur in that considerable labor and time are required to perform processing, assembly, and adjustments for obtaining the image forming lens having a predetermined level of performance.

Ordinarily, it may be considered that an aspherical lens for compensation for the distortion may be located on the image side of the image-side telecentric image forming lens in order to suppress the distortion of the image forming lens, and that the number of the lenses may be reduced.

However, since aperture diameter on the image side of the image-side telecentric image forming lens is large, the diameter of the aspherical lens located on the image side is set to be large in accordance with the aperture diameter described above. Therefore, the problems occur in that the production of the aspherical lens having the large diameter with, e.g. a glass forming process, is not easy to conduct.

The demands for suppression of the distortion and enhancement of the MTF performance described above, the demand for enhancement of the light utilization efficiency described above, the problems with regard to the difficulty of the production of the aspherical lens described above, and the like, occur also with the image forming optical system of the projecting exposure apparatuses, wherein the two-dimensional pattern of the light, which has been obtained from the modulation of the incident light performed by the exposure mask, is projected onto the photosensitive material, and the photosensitive material is thus exposed to the two-dimensional pattern of the light.

### SUMMARY OF THE INVENTION

The primary object of the present invention is to provide a projecting exposure apparatus, wherein projection of a two-dimensional pattern of light is capable of being performed such that distortion is suppressed, such that MTF performance is enhanced, and such that efficiency with which light having been produced by a light source is utilized is enhanced.

The present invention provides a first projecting exposure apparatus, comprising:

i) spatial light modulation means for performing spatial light modulation of light, which has been produced by a light source, and

ii) an image-side telecentric image forming optical system for forming an image of a two-dimensional pattern of the light, which has been obtained from the spatial light modulation performed by the spatial light modulation means, on a photosensitive material,

the two-dimensional pattern of the light being projected through the image forming optical system onto the photosensitive material, the photosensitive material being thus exposed to the two-dimensional pattern of the light,

wherein at least either one of two pupil-adjacent lenses, which are adjacent to each other with an entrance pupil position in the image forming optical system intervening between the two pupil-adjacent lenses, is constituted such that at least either one of lens surfaces of the pupil-adjacent lens is an aspherical surface.

The present invention also provides a second projecting exposure apparatus, comprising:

i) an exposure mask for performing modulation of light, which has been produced by a light source, and

ii) an image-side telecentric image forming optical system for forming an image of a two-dimensional pattern of the light, which has been obtained from the modulation performed by the exposure mask, on a photosensitive material,

the two-dimensional pattern of the light being projected through the image forming optical system onto the photosensitive material, the photosensitive material being thus exposed to the two-dimensional pattern of the light,

wherein at least either one of two pupil-adjacent lenses, which are adjacent to each other with an entrance pupil position in the image forming optical system intervening between the two pupil-adjacent lenses, is constituted such that at least either one of lens surfaces of the pupil-adjacent lens is an aspherical surface.

Each of the first and second projecting exposure apparatuses in accordance with the present invention may be modified such that at least either one of the two pupil-adjacent lenses is constituted such that the lens surface of the pupil-adjacent lens, which lens surface is opposite to the other lens surface located on the side of the entrance pupil position, is the aspherical surface.

Alternatively, each of the first and second projecting exposure apparatuses in accordance with the present invention may be modified such that at least either one of the two pupil-adjacent lenses is constituted such that both the lens surfaces of the pupil-adjacent lens are the aspherical surfaces.

Also, each of the first and second projecting exposure apparatuses in accordance with the present invention should preferably be modified such that a first pupil-adjacent lens, which is one of the two pupil-adjacent lenses and is located on the side opposite to the side of the photosensitive material, is constituted such that an absolute value of a coefficient representing a conic component of a configuration of an incidence-side lens surface of the first pupil-adjacent lens is larger than the absolute value of the coefficient representing the conic component of the configuration of a radiating-side lens surface of the first pupil-adjacent lens.

Further, each of the first and second projecting exposure apparatuses in accordance with the present invention should preferably be modified such that a second pupil-adjacent lens, which is one of the two pupil-adjacent lenses and is located on the side of the photosensitive material, is constituted such that an absolute value of a coefficient representing a conic component of a configuration of an incidence-side lens surface of the second pupil-adjacent lens is smaller than the absolute value of the coefficient representing the conic component of the configuration of a radiating-side lens surface of the second pupil-adjacent lens.

Each of the first and second projecting exposure apparatuses in accordance with the present invention should more preferably be modified such that the first pupil-adjacent lens is constituted such that a ratio δo=δ1/δ2 of a value δ1, which is the absolute value of the coefficient representing the conic component of the configuration of the incidence-side lens surface of the first pupil-adjacent lens, to a value δ2, which is the absolute value of the coefficient representing the conic component of the configuration of the radiating-side lens surface of the first pupil-adjacent lens, satisfies a condition 1<δo<70.

Also, each of the first and second projecting exposure apparatuses in accordance with the present invention should more preferably be modified such that the second pupil-adjacent lens is constituted such that a ratio γo=γ1/γ2 of a value γ1, which is the absolute value of the coefficient representing the conic component of the configuration of the radiating-side lens surface of the second pupil-adjacent lens, to a value γ2, which is the absolute value of the coefficient representing the conic component of the configuration of the incidence-side lens surface of the second pupil-adjacent lens, satisfies a condition 1<γo<70.

Further, each of the first and second projecting exposure apparatuses in accordance with the present invention may be modified such that the light, which passes through the image forming optical system, has a wavelength falling within the range of 350 nm to 450 nm.

Furthermore, the first projecting exposure apparatus in accordance with the present invention may be modified such that the spatial light modulation means is a digital micromirror device.

The exposure mask employed in the second projecting exposure apparatus in accordance with the present invention comprises a plurality of regions, each of which reflects, absorbs, or transmits the incident light. The exposure mask forms the two-dimensional pattern of the light in accordance with a difference in light modulation characteristics among the plurality of the regions constituting the exposure mask. For example, the exposure mask may be obtained with a process, wherein a two-dimensional pattern capable of absorbing the light is formed on a glass plate capable of transmitting the light. Alternatively, the exposure mask may be obtained with a process, wherein a two-dimensional pattern capable of absorbing the light is formed on a glass plate capable of reflecting the light.

The inventors have paid particular attention to a lens in the image-side telecentric image forming optical system, which lens is capable of being kept small in diameter, i.e. which lens is comparatively easy to process as an aspherical lens, and have conducted extensive research to obtain an image forming optical system, wherein the distortion is capable of being suppressed, and wherein the MTF performance is capable of being enhanced. As a result, the inventors found that, in cases where a lens, which is located in the vicinity of the entrance pupil position and has comparatively large effects upon the optical performance, is constituted as the aspherical lens, and in cases where particularly accurate processing, assembly, and adjustments are performed on several lenses containing the aspherical lens, which lenses are located in the vicinity of the entrance pupil position, the image forming optical system having the desired performance with the suppressed distortion and the enhanced MTF performance is capable of being obtained. The present invention is based upon the findings described above.

With the first projecting exposure apparatus in accordance with the present invention, the image-side telecentric image forming optical system forms the image of the two-dimensional pattern of the light, which has been obtained from the spatial light modulation performed by the spatial light modulation means, on the photosensitive material. Also, with the first projecting exposure apparatus in accordance with the present invention, at least either one of the two pupil-adjacent lenses, which are adjacent to each other with the entrance pupil position in the image forming optical system intervening between the two pupil-adjacent lenses, is constituted such that at least either one of the lens surfaces of the pupil-adjacent lens is the aspherical surface. With the second projecting exposure apparatus in accordance with the present invention, the image-side telecentric image forming optical system forms the image of the two-dimensional pattern of the light, which has been obtained from the modulation performed by the exposure mask, on the photosensitive material. Also, with the second projecting exposure apparatus in accordance with the present invention, at least either one of the two pupil-adjacent lenses, which are adjacent to each other with the entrance pupil position in the image forming optical system intervening between the two pupil-adjacent lenses, is constituted such that at least either one of the lens surfaces of the pupil-adjacent lens is the aspherical surface. Specifically, with each of the first and second projecting exposure apparatuses in accordance with the present invention, for example, at least either one of the two pupil-adjacent lenses may be constituted such that the lens surface of the pupil-adjacent lens, which lens surface is opposite to the other lens surface located on the side of the entrance pupil position, is the aspherical surface. Alternatively, at least either one of the two pupil-adjacent lenses may be constituted such that both the lens surfaces of the pupil-adjacent lens are the aspherical surfaces. Therefore, with each of the first and second projecting exposure apparatuses in accordance with the present invention, the diameter of the aspherical lens is capable of being kept small such that the aspherical lens is comparatively easy to produce. By the utilization of the aspherical lens, the distortion of the image forming optical system described above is capable of being kept small (e.g., as small as at most 1μm), and the MTF performance is capable of being enhanced. Also, the number of the lenses constituting the image forming optical system is capable of being kept small. Accordingly, the efficiency with which the light having been produced by the light source is utilized is capable of being enhanced, the distortion of the image forming optical system is capable of being suppressed, and the MTF performance is capable of being enhanced.

Each of the first and second projecting exposure apparatuses in accordance with the present invention may be modified such that the light, which passes through the image forming optical system, has a wavelength falling within the range of 350 nm to 450 nm. Ordinarily, the transmittances of the lens members with respect to the light having wavelengths falling within the range described above are low. Therefore, with the aforesaid modification of each of the first and second projecting exposure apparatuses in accordance with the present invention, marked effects of the reduction in number of the lenses constituting the image forming optical system upon the enhancement of the light utilization efficiency are capable of being obtained.

Also, each of the first and second projecting exposure apparatuses in accordance with the present invention may be modified such that the first pupil-adjacent lens, which is one of the two pupil-adjacent lenses and is located on the side opposite to the side of the photosensitive material, is constituted such that the absolute value of the coefficient representing the conic component of the configuration of the incidence-side lens surface of the first pupil-adjacent lens is larger than the absolute value of the coefficient representing the conic component of the configuration of the radiating-side lens surface of the first pupil-adjacent lens. Further, each of the first and second projecting exposure apparatuses in accordance with the present invention may be modified such that the second pupil-adjacent lens, which is one of the two pupil-adjacent lenses and is located on the side of the photosensitive material, is constituted such that the absolute value of the coefficient representing the conic component of the configuration of the incidence-side lens surface of the second pupil-adjacent lens is smaller than the absolute value of the coefficient representing the conic component of the configuration of the radiating-side lens surface of the second pupil-adjacent lens. With each of the modifications described above, the distortion of the image forming optical system described above is capable of being reliably kept small, and the number of the lenses constituting the image forming optical system is capable of being reliably kept small. Therefore, the efficiency with which the light having been produced by the light source is utilized is capable of being enhanced, and the distortion occurring at the time of the projection of the two-dimensional pattern of the light is capable of being suppressed even further.

Each of the first and second projecting exposure apparatuses in accordance with the present invention may further be modified such that the first pupil-adjacent lens is constituted such that the ratio δo=δ1/δ2 of the value δ1, which is the absolute value of the coefficient representing the conic component of the configuration of the incidence-side lens surface of the first pupil-adjacent lens, to the value δ2, which is the absolute value of the coefficient representing the conic component of the configuration of the radiating-side lens surface of the first pupil-adjacent lens, satisfies the condition 1<δo<70. Also, each of the first and second projecting exposure apparatuses in accordance with the present invention may further be modified such that the second pupil-adjacent lens is constituted such that the ratio γo=γ1/γ2 of the value γ1, which is the absolute value of the coefficient representing the conic component of the configuration of the radiating-side lens surface of the second pupil-adjacent lens, to the value γ2, which is the absolute value of the coefficient representing the conic component of the configuration of the incidence-side lens surface of the second pupil-adjacent lens, satisfies the condition 1<γo<70. With each of the modifications described above, the distortion of the image forming optical system described above is capable of being reliably kept small, and the MTF performance is capable of being reliably enhanced. Also, the number of the lenses constituting the image forming optical system is capable of being more reliably kept small. Therefore, the efficiency with which the light having been produced by the light source is utilized is capable of being enhanced, the distortion occurring at the time of the projection of the two-dimensional pattern of the light is capable of being suppressed, and the MTF performance is capable of being enhanced.

### BRIEF DESCRIPTION OF THE DRAWINGS

FIG. 1 is a developed conceptual view showing an exposure head in an embodiment of the projecting exposure apparatus in accordance with the present invention,

FIG. 2 is a side view showing a constitution of the exposure head along optical paths of light beams traveling through the exposure head,

FIG. 3 is a perspective view showing a DMD,

FIG. 4 is a side view showing an image-side telecentric image forming optical system, in which a pupil-adjacent lens has an aspherical surface,

FIG. 5A is a table showing particulars and performance in Examples 1 to 4 and Comparative Example 1,

FIG. 5B is a table showing particulars and performance in Examples 5 and 6 and Comparative Example 1,

FIG. 6A is a diagram showing design values in Comparative Example 1,

FIG. 6B is a schematic view showing a lens constitution and optical paths in Comparative Example 1,

FIG. 7A is a diagram showing design values in Example 1,

FIG. 7B is a schematic view showing a lens constitution and optical paths in Example 1,

FIG. 8A is a diagram showing design values in Example 2,

FIG. 8B is a schematic view showing a lens constitution and optical paths in Example 2,

FIG. 9A is a diagram showing design values in Example 3,

FIG. 9B is a schematic view showing a lens constitution and optical paths in Example 3,

FIG. 10A is a diagram showing design values in Example 4,

FIG. 10B is a schematic view showing a lens constitution and optical paths in Example 4,

FIG. 11A is a diagram showing design values in Example 5,

FIG. 11B is a schematic view showing a lens constitution and optical paths in Example 5,

FIG. 12A is a diagram showing design values in Example 6,

FIG. 12B is a schematic view showing a lens constitution and optical paths in Example 6,

FIG. 13 is a perspective view showing an appearance of the embodiment of the projecting exposure apparatus in accordance with the present invention,

FIG. 14 is a perspective view showing how an exposure operation is performed by the projecting exposure apparatus of FIG. 13,

FIG. 15A is a plan view showing exposure-processed regions, which are formed on a photosensitive material,

FIG. 15B is an explanatory view showing an array of exposure processing areas, each of which is subjected to exposure processing performed by one of exposure heads,

FIG. 16 is a plan view showing a laser beam combining light source,

FIG. 17 is a side view showing the laser beam combining light source,

FIG. 18 is a front view showing the laser beam combining light source,

FIG. 19 is an enlarged plan view showing optical elements of the laser beam combining light source,

FIG. 20A is a perspective view showing a light source unit,

FIG. 20B is an enlarged view showing a part of a laser beam radiating section,

FIG. 20C is a front view showing an example of an array of optical fibers at the laser beam radiating section,

FIG. 20D is a front view showing a different example of an array of optical fibers at the laser beam radiating section,

FIG. 21 is a view showing how a multimode optical fiber of the laser beam combining light source and the optical fiber at the laser beam radiating section are connected to each other,

FIG. 22A is a plan view showing how the photosensitive material is exposed to light beams in cases where the DMD is located in an orientation, which is not oblique,

FIG. 22B is a plan view showing how the photosensitive material is exposed to the light beams in cases where the DMD is located in an oblique orientation,

FIG. 23A is an explanatory view showing an example of a used region in the DMD, and

FIG. 23B is an explanatory view showing a different example of a used region in the DMD.

### DESCRIPTION OF THE PREFERRED EMBODIMENTS

The present invention will hereinbelow be described in further detail with reference to the accompanying drawings.

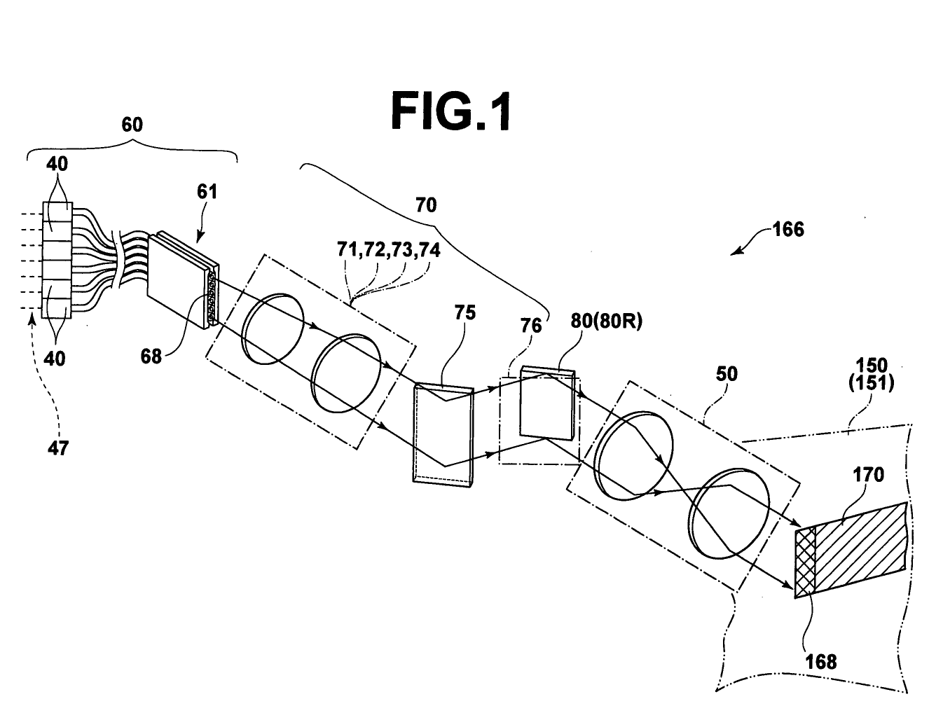

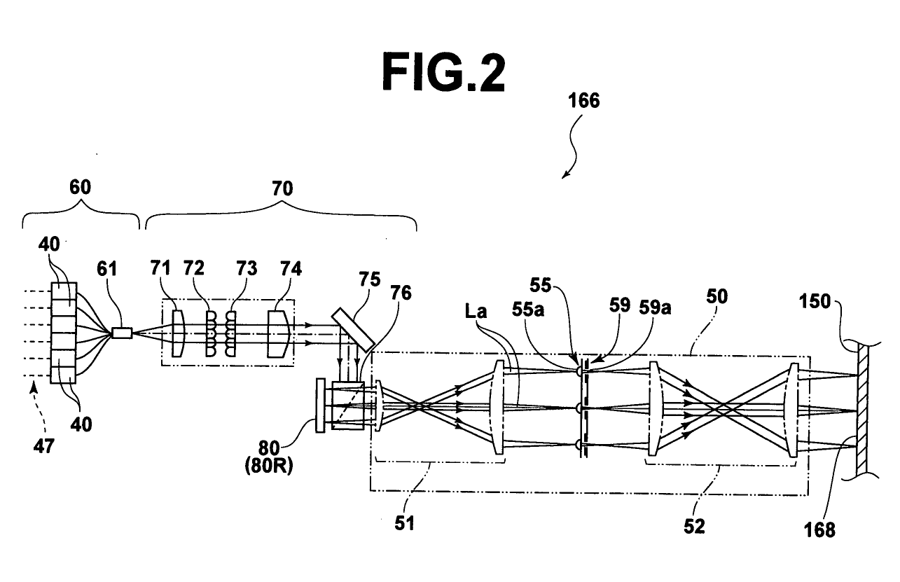

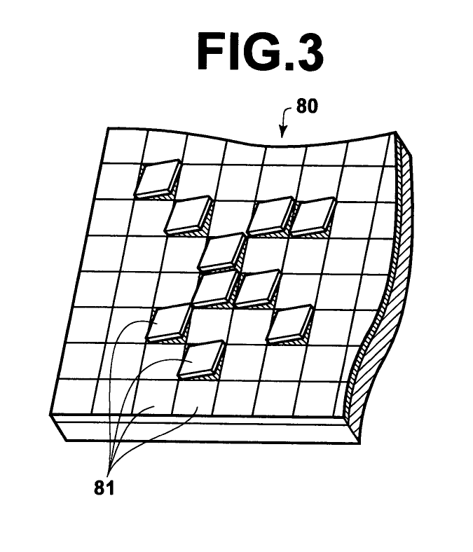

FIG. 1 is a developed conceptual view showing an exposure head of an embodiment of the projecting exposure apparatus in accordance with the present invention. FIG. 2 is a side view showing a constitution of the exposure head along optical paths of light beams traveling through the exposure head. FIG. 3 is a perspective view showing a DMD.

The embodiment of the projecting exposure apparatus in accordance with the present invention comprises a DMD 80 acting as the spatial light modulation means for performing spatial light modulation of light, which has been produced by a light source unit 60 acting as the light source. The projecting exposure apparatus also comprises an image forming optical system 50, which is provided with a first image forming optical system 51 and a second image forming optical system 52. The image forming optical system 50 acts as the image-side telecentric image forming optical system for forming an image of a two-dimensional pattern of the light, which has been obtained from the spatial light modulation performed by the DMD 80, on a photosensitive material 150. With the projecting exposure apparatus, the two-dimensional pattern of the light is projected through the first image forming optical system 51 and the second image forming optical system 52 onto the photosensitive material 150, and the photosensitive material 150 is thus exposed to the two-dimensional pattern of the light. The light source unit 60, the DMD 80, the image forming optical system 50, and the like, are optical elements constituting an exposure head 166, which will be described later. By way of example, the two-dimensional pattern may be a pattern of an image which is to be displayed, an image pattern representing a circuit pattern of electric wiring, or the like. Also, the photosensitive material 150 may be a photosensitive material overlaid on a board for the formation of a printed circuit board, on which a circuit pattern is formed. Alternatively, the photosensitive material 150 maybe a photosensitive material overlaid on a base plate for liquid crystal displaying or on a base plate for the formation of a plasma display panel.

The image forming optical system 50 will hereinbelow be described in detail.

### Image Forming Optical System 50

As illustrated in FIG. 1 and FIG. 2, the image forming optical system 50, which is one of the optical elements constituting the exposure head 166, comprises the first image forming optical system 51 and the second image forming optical system 52 described above. The image forming optical system 50 also comprises a microlens array 55 and an aperture array 59, which are located in the optical paths between the first image forming optical system 51 and the second image forming optical system 52. The microlens array 55 is constituted of a plurality of microlenses 55a, 55a, . . . Each of the microlenses 55a, 55a, . . . is located at a position corresponding to one of micromirrors 81, 81, . . . of the DMD 80 (illustrated in FIG. 3), such that the microlens 55a transmits a light beam having been reflected from the corresponding micromirror 81 of the DMD 80. Also, the aperture array 59 comprises a plurality of apertures 59a, 59a, . . . Each of the apertures 59a, 59a, . . . is located at a position corresponding to one of the microlenses 55a, 55a, . . . of the microlens array 55, such that the aperture 59a allows the passage of the light beam, which has passed through the corresponding microlens 55a of the microlens array 55.

In the image forming optical system 50 having the constitution described above, the image of the micromirrors 81, 81, . . . , which image is formed with the light beams having been reflected from the micromirrors 81, 81, . . . of the DMD 80, is enlarged by the first image forming optical system 51 to a size three times as large as the size of the original image. Each of telecentric light beams La, La, . . . corresponding respectively to the micromirrors 81, 81, . . . , which light beam has passed through the first image forming optical system 51 after being reflected from the corresponding micromirror 81, is collected by the corresponding microlens 55a of the microlens array 55, which is located in the vicinity of the position of image formation with the first image forming optical system 51. Each of the light beams La, La, . . . , which light beam has thus been collected by the corresponding microlens 55a, passes through the corresponding aperture 59a. The size of the image constituted of the light beams La, La, . . . , which have passed through the microlens array 55 and the aperture array 59, is enlarged even further by the second image forming optical system 52 by a factor of 1.67. The image constituted of the light beams La, La, . . . , which image has the thus enlarged size is formed on a photosensitive surface 151 of the photosensitive material 150.

In cases where each of pixels constituting the image of the two-dimensional pattern, i.e. each of the light beams La, La, . . . , which have passed through the corresponding microlenses 55a, 55a, . . . after being reflected from the corresponding micromirrors 81, 81, . . . , undergoes thickening due to aberrations of the optical elements described above, and the like, the light beam La is capable of being shaped by the corresponding aperture 59a such that the spot size on the photosensitive surface 151 becomes identical with a predetermined size. Also, as described above, each of the light beams La, La, . . . , which light beam has been reflected from one of the micromirrors 81, 81, . . . is passed through the aperture 59a, which corresponds to the micromirror 81. Therefore, cross talk between the micromirrors 81, 81, . . . (the pixels) is capable of being prevented from occurring, and the extinction ratio in on-off operations of each of the micromirrors 81, 81, . . . at the time of the exposure operation is capable of being enhanced.

The state, in which each of the micromirrors 81, 81, . . . is inclined at the predetermined angle such that the light beam having been reflected from the micromirror 81 travels toward the image forming optical system 50, is the on state of the micromirror 81. Also, the state, in which each of the micromirrors 81, 81, . . . is inclined at an angle different from the predetermined angle such that the light beam having been reflected from the micromirror 81 travels along a direction shifted from the direction of the optical path heading toward the image forming optical system 50, is the off state of the micromirror 81. The image of the light beam, which has been reflected from the micromirror 81 in the on state, is formed on the photosensitive surface 151, and the photosensitive material 150 is thus exposed to the light beam. Specifically, each of the micromirrors 81, 81, . . . modulates the incident light in accordance with the alteration of the angle of inclination of the micromirror 81. Also, the DMD 80 alters the angle of inclination of each of the micromirrors 81, 81, . . . in accordance with a predetermined control signal and thereby performs the spatial light modulation of the incident light.

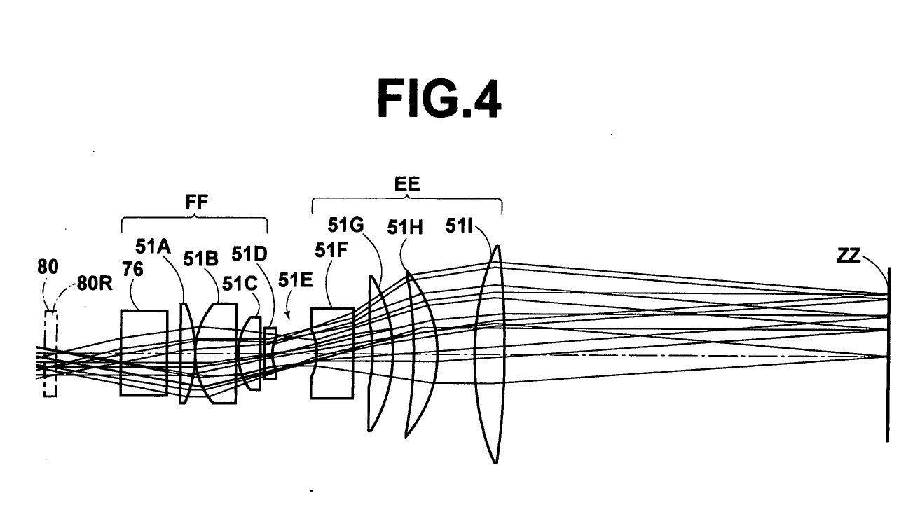

The first image forming optical system 51, which is the image-side telecentric image forming optical system, will be described hereinbelow with reference to FIG. 4 through FIGS. 12A and 12B.

FIG. 4 is a side view showing the first image forming optical system 51, which is the image-side telecentric image forming optical system. As illustrated in FIG. 4 (and in FIG. 1 and FIG. 2), a prism 76 is located between the DMD 80 and the first image forming optical system 51. The prism 76 is a plane-parallel TIR prism (total reflection prism) composed of a combination of two triangular prisms. The prism 76 totally reflects the light, which has been reflected from a mirror 75, toward the DMD 80 and transmits the light, which has been reflected from the DMD 80.

The first image forming optical system 51 is provided with a pre-pupil set lens FF comprising a first lens 51A, a second lens 51B, a third lens 51C, and a fourth lens 51D, which are located in this order as counted from the incidence side. The first image forming optical system 51 is also provided with a post-pupil set lens EE comprising a fifth lens 51F, a sixth lens 51G, a seventh lens 51H, and an eighth lens 51I, which are located in this order as counted from the incidence side following the fourth lens 51D. An entrance pupil position 51E is located between the fourth lens 51D of the pre-pupil set lens FF and the fifth lens 51F of the post-pupil set lens EE.

The fourth lens 51D and the fifth lens 51F constitute the two pupil-adjacent lenses, which are adjacent to each other with the entrance pupil position 51E intervening between the two pupil-adjacent lenses. The fourth lens 51D, which is located on the side opposite to the side of the photosensitive material 150, is the first pupil-adjacent lens. The fifth lens 51F, which is located on the side of the photosensitive material 150, is the second pupil-adjacent lens.

The light beams having been reflected from the certain micromirrors 81, 81, . . . , which are among the micromirrors 81, 81, . . . of the DMD 80 and are in the on state, and having passed through the prism 76 enter into the image forming optical system 50. The light beams pass through the pre-pupil set lens FF, the entrance pupil position 51E, and the post-pupil set lens EE, in this order, and travel toward an image surface ZZ. The DMD 80 and the image surface ZZ have an image formation relationship of a magnification of 1:3 (i.e., 3-power magnification). The microlens array 55 is located at the image surface ZZ.

The second image forming optical system 52 forms the image, which is constituted of the light beams having been collected by the microlens array 55, on the photosensitive material 150.

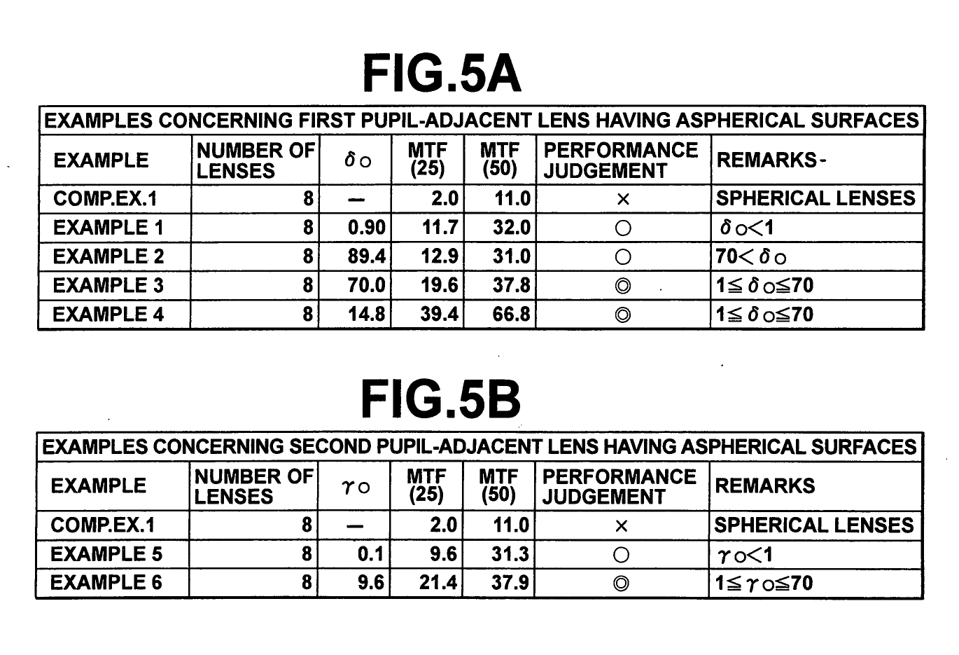

The first image forming optical system 51 will further be illustrated by six examples and one comparative example and with reference to FIG. 4 and FIGS. 5A and 5B. In each of the six examples and the one comparative example, the relationship between the MTF performance and a conic coefficient ratio δo or a conic coefficient ratio γo, and the like, were investigated. The conic coefficient ratio δo is the ratio δo==δ1/δ2 of the value δ1, which is the absolute value of the coefficient representing the conic component of the configuration of the incidence-side lens surface of the first pupil-adjacent lens, to the value δ2, which is the absolute value of the coefficient representing the conic component of the configuration of the radiating-side lens surface of the first pupil-adjacent lens. (The coefficient representing the conic component will hereinbelow be referred to as the conic coefficient.) The conic coefficient ratio γo is the ratio γo=γ1/γ2 of the value γ1, which is the absolute value of the conic coefficient of the configuration of the radiating-side lens surface of the second pupil-adjacent lens, to the value γ2, which is the absolute value of the conic coefficient of the configuration of the incidence-side lens surface of the second pupil-adjacent lens. FIG. 5A is a table showing particulars and performance in Examples 1 to 4, in each of which the first pupil-adjacent lens has an aspherical surface, and Comparative Example 1. FIG. 5B is a table showing particulars and performance in Examples 5 and 6, in each of which the second pupil-adjacent lens has an aspherical surface, and Comparative Example 1

In each of the six examples and the one comparative example, as in the constitution illustrated in FIG. 4, the pre-pupil set lens comprising the four lenses was located on the incidence side of the entrance pupil position, and the post-pupil set lens comprising the four lenses was located on the radiating side of the entrance pupil position. Therefore, in the explanations of the six examples and the one comparative example, the constitution similar to the constitution shown in FIG. 4 and the symbols similar to the symbols shown in FIG. 4 are utilized.

Also, the constitution in each of the six examples and the one comparative example was designed such that the distortion was equal to at most the predetermined value, i.e. such that the distortion was equal to at most 1 μm. The design values will be described later.

Further, the explanations of the six examples and the one comparative example are made below with reference to first to fifth conditions defined below.

First condition: At least either one of the two pupil-adjacent lenses, which are adjacent to each other with the entrance pupil position intervening between the two pupil-adjacent lenses, is constituted such that at least either one of the lens surfaces of the pupil-adjacent lens is an aspherical surface.

Second condition: At least either one of the two pupil-adjacent lenses is constituted such that the lens surface of the pupil-adjacent lens, which lens surface is opposite to the other lens surface located on the side of the entrance pupil position, is the aspherical surface.

Third condition: At least either one of the two pupil-adjacent lenses is constituted such that both the lens surfaces of the pupil-adjacent lens are the aspherical surfaces.

Fourth condition: The first pupil-adjacent lens is constituted such that the absolute value of the conic coefficient of the configuration of the incidence-side lens surface of the first pupil-adjacent lens is larger than the absolute value of the conic coefficient of the configuration of the radiating-side lens surface of the first pupil-adjacent lens. Alternatively, the second pupil-adjacent lens is constituted such that the absolute value of the conic coefficient of the configuration of the incidence-side lens surface of the second pupil-adjacent lens is smaller than the absolute value of the conic coefficient of the configuration of the radiating-side lens surface of the second pupil-adjacent lens.

Fifth condition: The first pupil-adjacent lens is constituted such that the conic coefficient ratio δo of the first pupil-adjacent lens satisfies a condition 1<δo<70. Alternatively, the second pupil-adjacent lens is constituted such that the conic coefficient ratio γo of the second pupil-adjacent lens satisfies a condition 1<γo<70.

### COMPARATIVE EXAMPLE 1

In Comparative Example 1, the image forming lens was constituted of an optical system designed only with spherical lenses, and the constitution of the image forming lens did not satisfy any of the first condition to the fifth condition described above. As shown in FIG. 5A and FIG. 5B, the value of MTF (25) was equal to 2.0, and the value of MTF (50) was equal to 11.0. The MTF performance was thus low, and the predetermined MTF performance could not be obtained. The performance was judged as being “x.” The value of MTF (25) represents the MTF performance with respect to 25 cycle/mm. The value of MTF (50) represents the MTF performance with respect to 50 cycle/mm.

### EXAMPLE 1

In Example 1, the image forming lens was constituted such that both the lens surfaces of the fourth lens 51D acting as the first pupil-adjacent lens were the aspherical surfaces. The conic coefficient ratio δo was equal to 0.90. The constitution of the image forming lens satisfied the first condition, the second condition, and the third condition described above. As shown in FIG. 5A, the value of MTF (25) was equal to 11.7, and the value of MTF (50) was equal to 32.0. The predetermined MTF performance was thus capable of being obtained. The performance was judged as being “∘.”

### EXAMPLE 2

In Example 2, the image forming lens was constituted such that both the lens surfaces of the fourth lens 51D acting as the first pupil-adjacent lens were the aspherical surfaces. The conic coefficient ratio δo was equal to 89.4. The constitution of the image forming lens satisfied the first condition, the second condition, the third condition, and the fourth condition described above. As shown in FIG. 5A, the value of MTF (25) was equal to 12.9, and the value of MTF (50) was equal to 31.0. The predetermined MTF performance was thus capable of being obtained. The performance was judged as being “∘.”0

### EXAMPLE 3

In Example 3, the image forming lens was constituted such that both the lens surfaces of the fourth lens 51D acting as the first pupil-adjacent lens were the aspherical surfaces. The conic coefficient ratio δo was equal to 70.0. The constitution of the image forming lens satisfied all of the first condition, the second condition, the third condition, the fourth condition, and the fifth condition described above. As shown in FIG. 5A, the value of MTF (25) was equal to 19.6, and the value of MTF (50) was equal to 37.8. The MTF performance was markedly better than the predetermined MTF performance. The performance was judged as being “⊚.”

### EXAMPLE 4

In Example 4, the image forming lens was constituted such that both the lens surfaces of the fourth lens 51D acting as the first pupil-adjacent lens were the aspherical surfaces. The conic coefficient ratio δo was equal to 14.8. The constitution of the image forming lens satisfied all of the first condition, the second condition, the third condition, the fourth condition, and the fifth condition described above. As shown in FIG. 5A, the value of MTF (25) was equal to 39.4, and the value of MTF (50) was equal to 66.8. The MTF performance was markedly better than the predetermined MTF performance. The performance was judged as being “⊚.”

### EXAMPLE 5

In Example 5, the image forming lens was constituted such that both the lens surfaces of the fifth lens 51F acting as the second pupil-adjacent lens were the aspherical surfaces. The conic coefficient ratio γo was equal to 0.1. The constitution of the image forming lens satisfied the first condition, the second condition, and the third condition described above. As shown in FIG. 5B, the value of MTF (25) was equal to 9.6, and the value of MTF (50) was equal to 31.3. The predetermined MTF performance was thus capable of being obtained. The performance was judged as being “∘.”

### EXAMPLE 6

In Example 6, the image forming lens was constituted such that both the lens surfaces of the fifth lens 51F acting as the second pupil-adjacent lens were the aspherical surfaces. The conic coefficient ratio γo was equal to 9.6. The constitution of the image forming lens satisfied all of the first condition, the second condition, the third condition, the fourth condition, and the fifth condition described above. As shown in FIG. 5B, the value of MTF (25) was equal to 21.4, and the value of MTF (50) was equal to 37.9. The MTF performance was markedly better than the predetermined MTF performance. The performance was judged as being “⊚.”

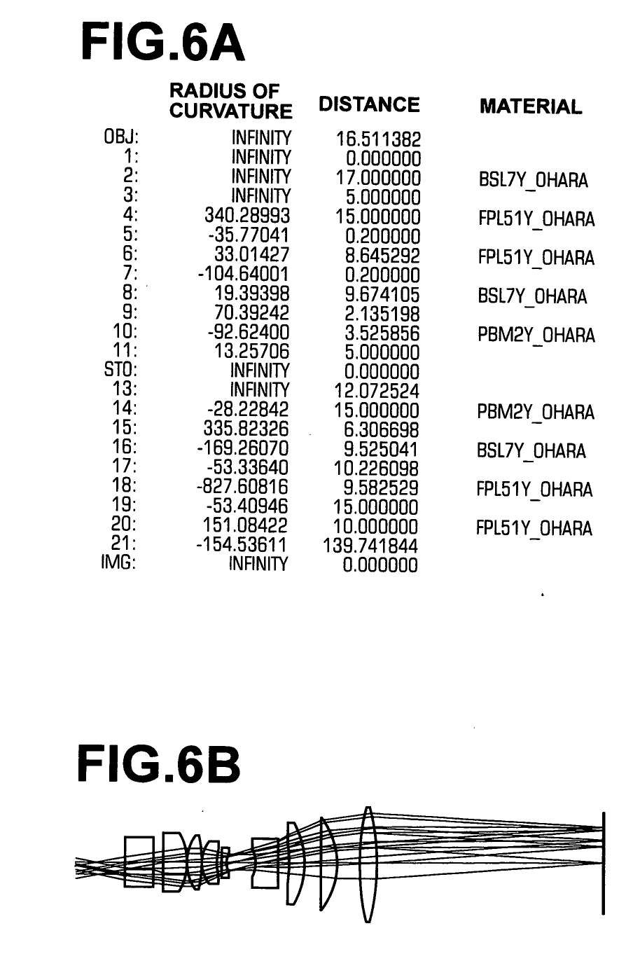

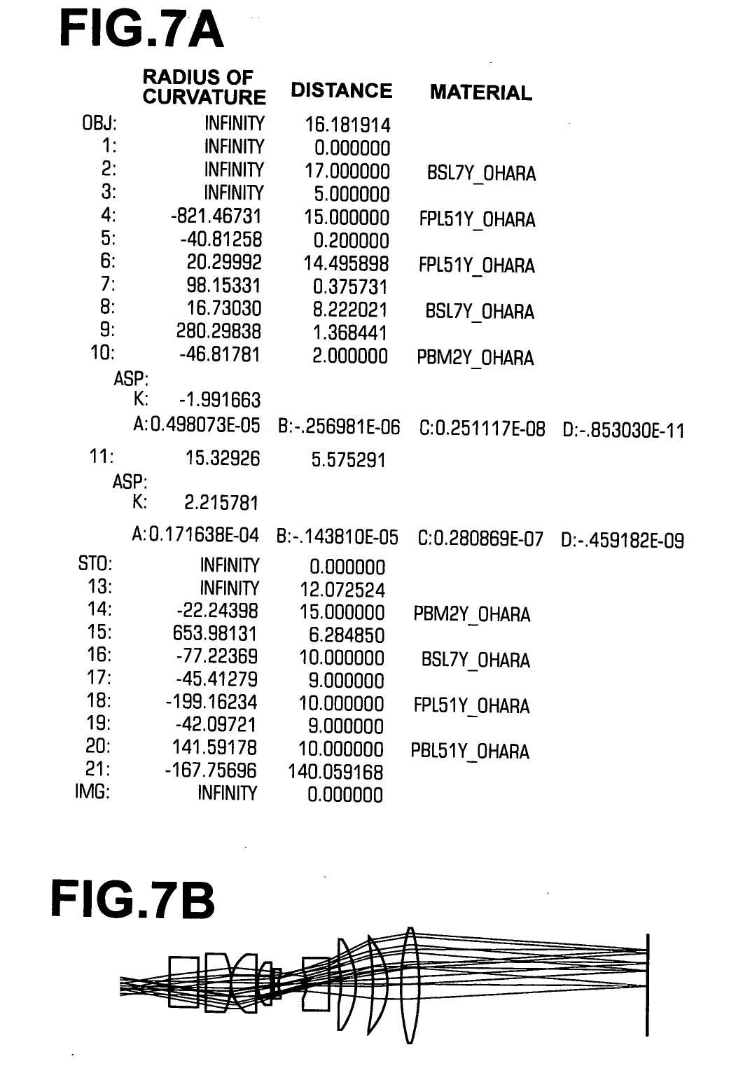

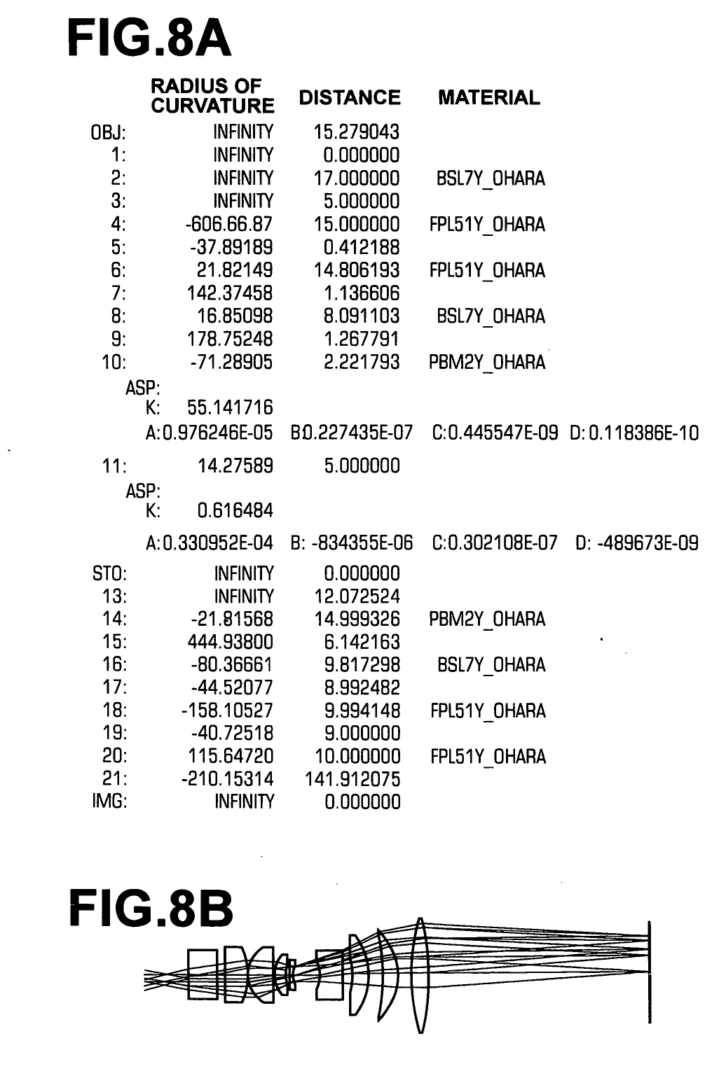

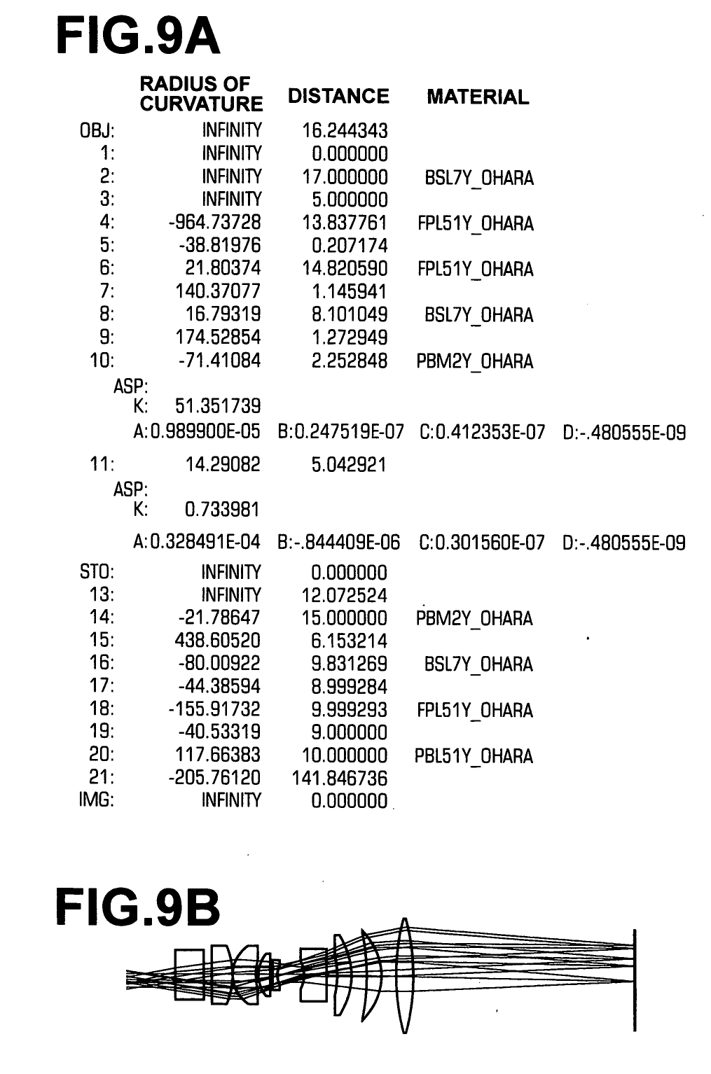

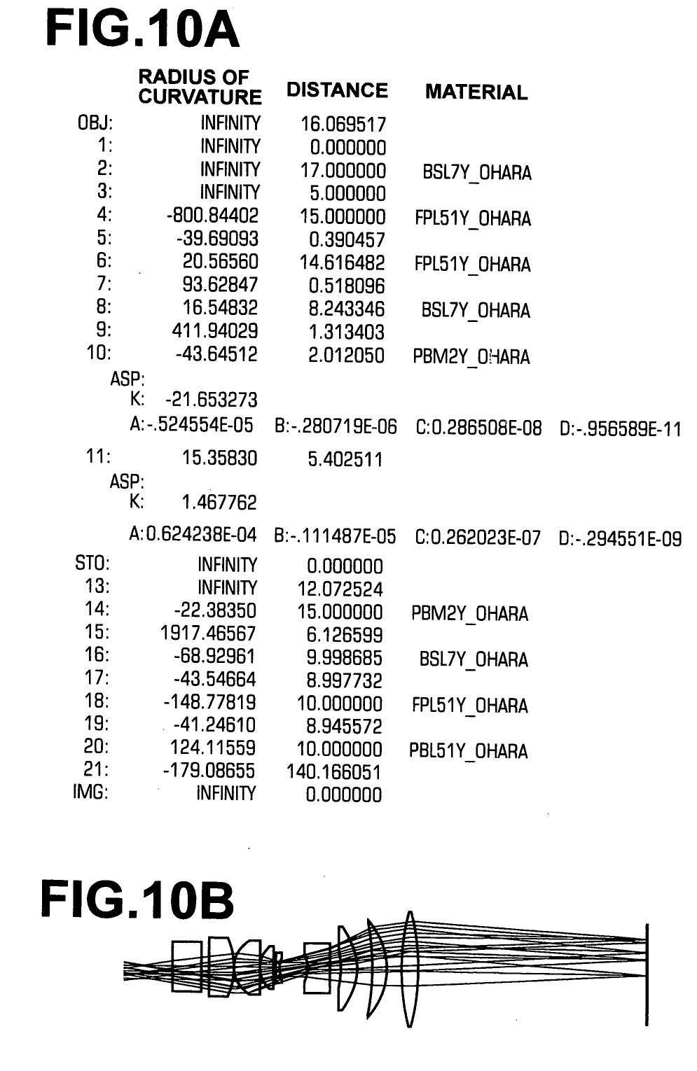

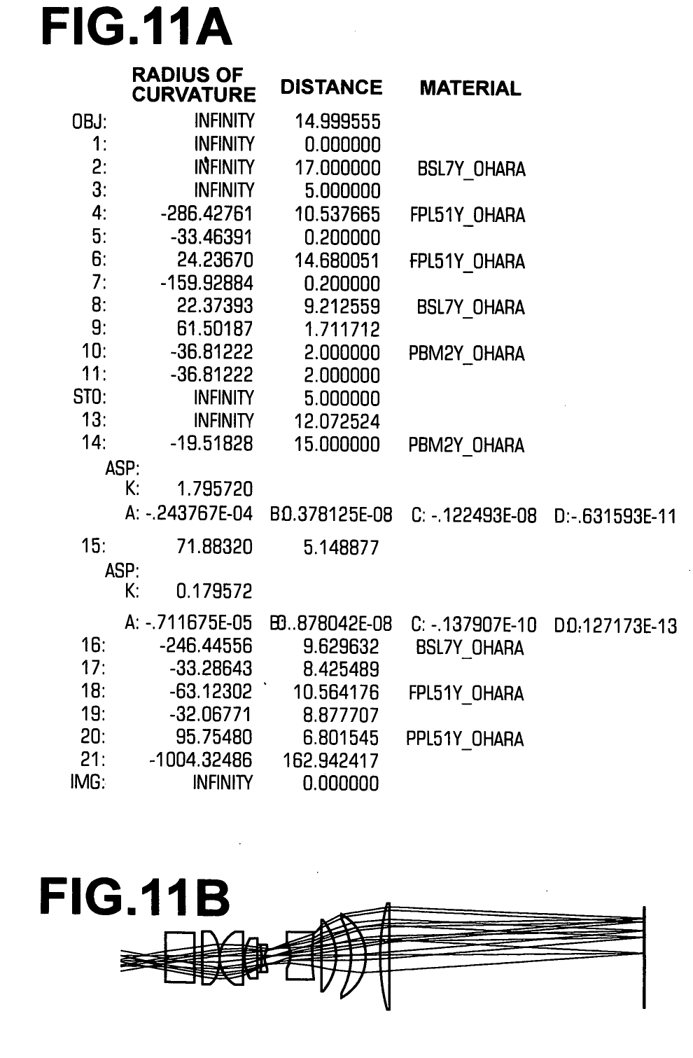

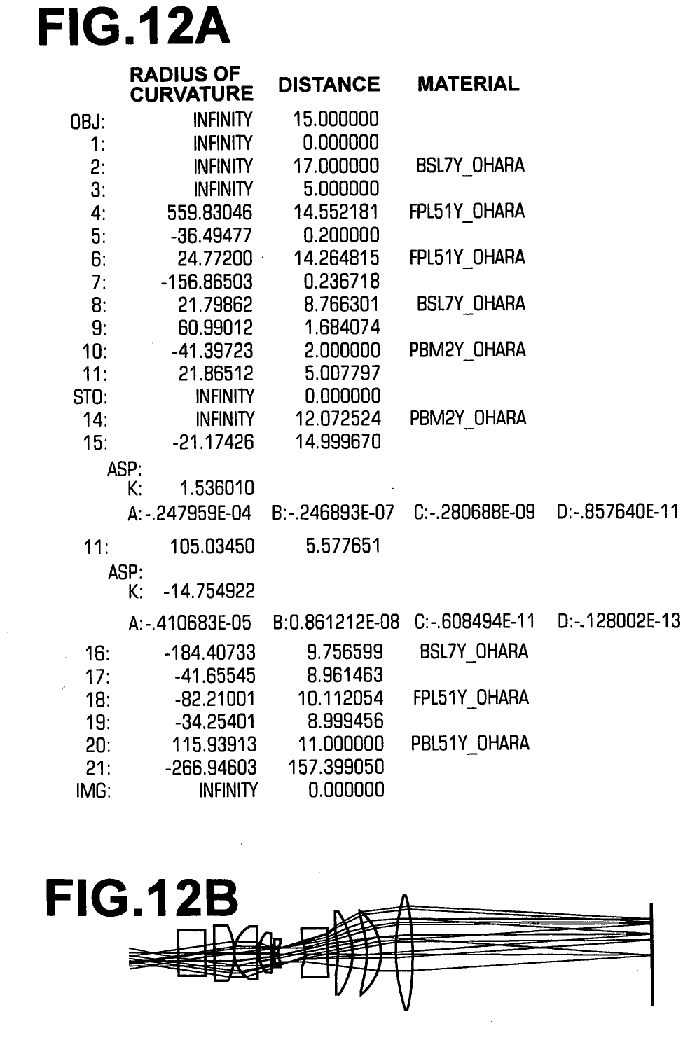

Design values, lens constitution, and optical paths in Comparative Example 1 and Examples 1 through Example 6 are shown in FIGS. 6A and 6B through FIGS. 12A and 12B. FIG. 6A is a diagram showing design values in Comparative Example 1. FIG. 6B is a schematic view showing a lens constitution and optical paths in Comparative Example 1. FIG. 7A is a diagram showing design values in Example 1. FIG. 7B is a schematic view showing a lens constitution and optical paths in Example 1. FIG. 8A is a diagram showing design values in Example 2. FIG. 8B is a schematic view showing a lens constitution and optical paths in Example 2. FIG. 9A is a diagram showing design values in Example 3. FIG. 9B is a schematic view showing a lens constitution and optical paths in Example 3. FIG. 10A is a diagram showing design values in Example 4. FIG. 10B is a schematic view showing a lens constitution and optical paths in Example 4. FIG. 11A is a diagram showing design values in Example 5. Figure 11B is a schematic view showing a lens constitution and optical paths in Example 5. FIG. 12A is a diagram showing design values in Example 6. FIG. 12B is a schematic view showing a lens constitution and optical paths in Example 6.

In each of FIG. 6A, FIG. 7A, FIG. 8A, FIG. 9A, FIG. 10A, FIG. 11A, and FIG. 12A, the optical devices represented by the design values of OBJ to IMG correspond, in the order from OBJ, 1, . . . , to . . . , 21, IMG, to the prism 76, the first lens 51A, the second lens 51B, the third lens 51C, the fourth lens 51D, the fifth lens 51F, the sixth lens 51G, the seventh lens 51H, and the eighth lens 51I. Also, in each of FIG. 7A, FIG. 8A, FIG. 9A, FIG. 10A, FIG. 11A, and FIG. 12A, ASP represents that the corresponding lens surface is the aspherical surface. The aspherical surface may be represented by the formula shown below.

Aspherical surface formula:
Z=cY²/[1+SQRT{1−(1+K)c²Y²}]+AY⁴+BY⁶+CY⁸+DY¹⁰
wherein K represents the conic coefficient, and c represents the curvature (i.e., c=1/radius of curvature).

As described above, in cases where at least either one of the two pupil-adjacent lenses is constituted such that at least either one of the lens surfaces of the pupil-adjacent lens is an aspherical surface, the number of the lenses need not be set to be large, the distortion of the image forming optical system is capable of being suppressed, and the MTF performance is capable of being enhanced. Each of Example 1 through Example 6 may be modified such that, in lieu of the DMD 80, an exposure mask 80R is located at the position of the DMD 80 acting as the spatial light modulation means. In such cases, the same effects as those described above are capable of being obtained. In such cases, instead of a transmission type exposure mask being utilized, a reflection type exposure mask is used.

The embodiment of the projecting exposure apparatus in accordance with the present invention, in which the image forming optical system 50 provided with the image-side telecentric image forming optical system is utilized, will hereinbelow be described in detail.

### Explanation of Entire Constitution of the Projecting Exposure Apparatus

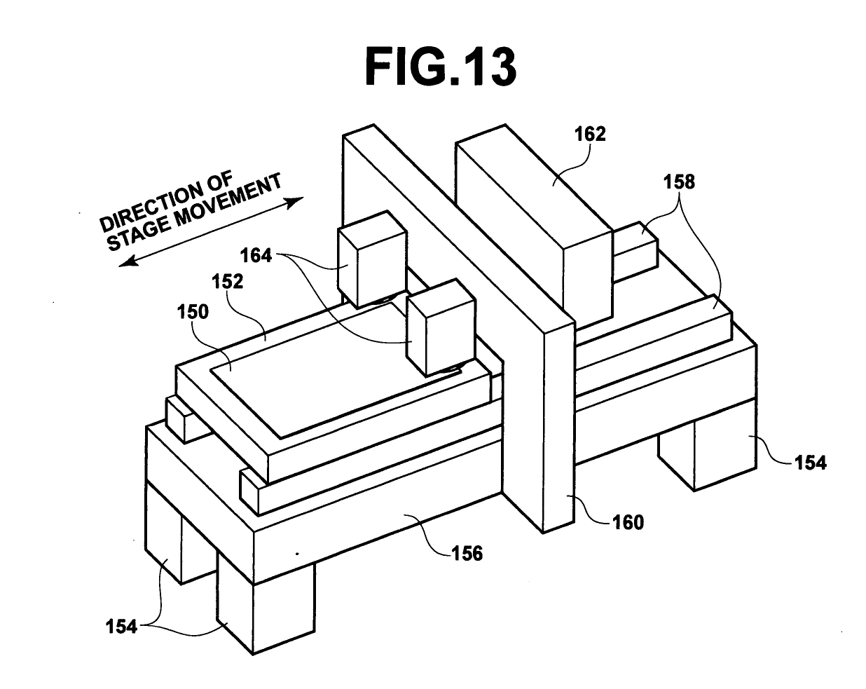

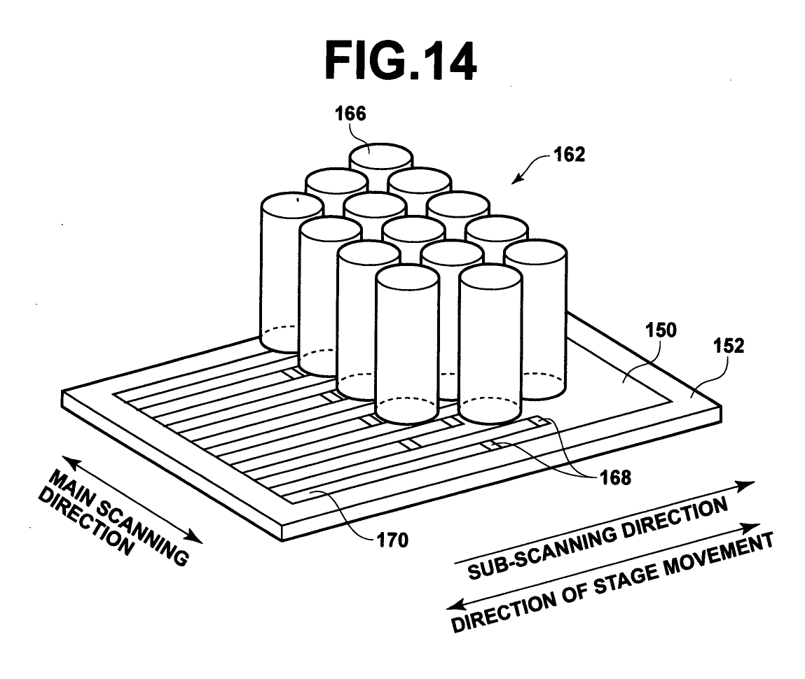

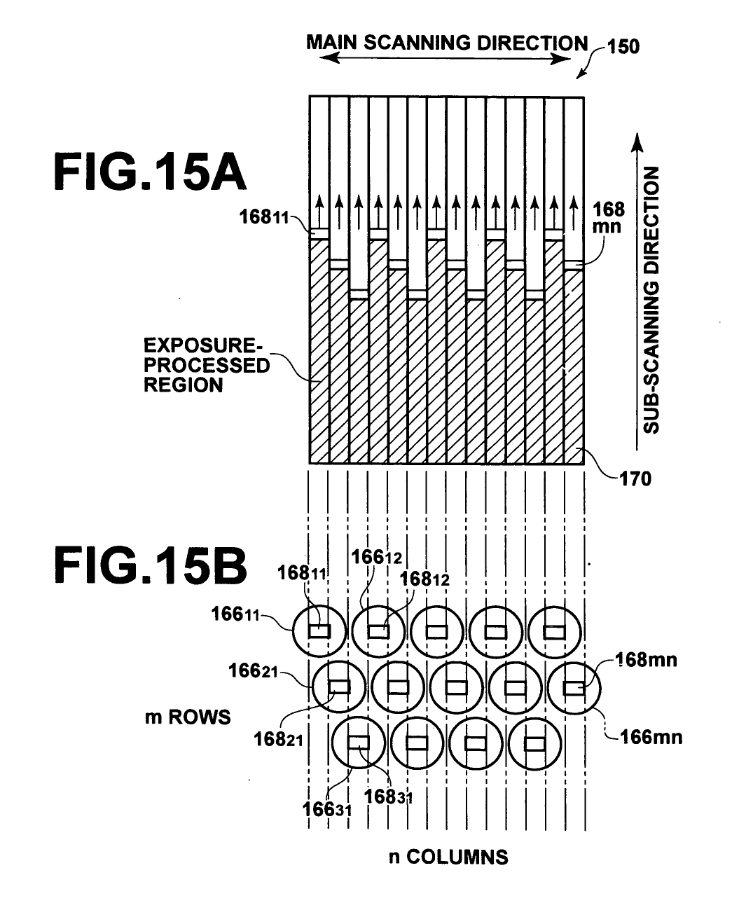

FIG. 13 is a perspective view showing an appearance of the embodiment of the projecting exposure apparatus in accordance with the present invention. FIG. 14 is a perspective view showing how an exposure operation is performed by the projecting exposure apparatus of FIG. 13. FIG. 15A is a plan view showing exposure-processed regions, which are formed on a photosensitive material. FIG. 15B is an explanatory view showing an array of exposure processing areas, each of which is subjected to exposure processing performed by one of exposure heads.

As illustrated in FIG. 13, the embodiment of the projecting exposure apparatus in accordance with the present invention comprises a scanner unit 162 and a main body section for supporting the scanner unit 162. The main body section is provided with a flat plate-like stage 152 for supporting the photosensitive material 150 on the surface by suction. The main body section is also provided with a support base 156 and two guides 158, 158 secured to the surface of the support base 156. The guides 158, 158 extend in a sub-scanning direction and support the stage 152 such that the stage 152 is capable of moving in the sub-scanning direction. The stage 152 is supported by the guides 158, 158 such that the stage 152 is capable of reciprocally moving in the sub-scanning direction. The stage 152 is located such that the longitudinal direction of the stage 152 coincides with the sub-scanning direction. The projecting exposure apparatus is provided with an actuating section (not shown) for moving the stage 152 along the guides 158, 158.

A scanner support section 160 having a portal shape is located at a middle part of the support base 156. The scanner support section 160 extends over the movement path of the stage 152 and supports the scanner unit 162. The scanner support section 160 supports the scanner unit 162 on one side of the scanner support section 160, which side is taken with respect to the sub-scanning direction. The scanner support section 160 is provided with two detection sensors 164, 164 on the other side of the scanner support section 160, which side is taken with respect to the sub-scanning direction. The detection sensors 164, 164 detect a leading end and a tail end of the photosensitive material 150. The scanner unit 162 and the detection sensors 164, 164 are thus secured to the opposite sides of the scanner support section 160 and are located above the movement path of the stage 152. The scanner unit 162 and the detection sensors 164, 164 are connected to a controller (not shown) for controlling the scanner unit 162 and the detection sensors 164, 164. In FIG. 13, the reference numerals 154, 154, . . . represent pillars.

As illustrated in FIG. 14 and FIGS. 15A, 15B, the scanner unit 162 is provided with a plurality of (e.g., 14) exposure heads 166, 166, . . . for irradiating the exposure light to the photosensitive material 150. The exposure heads 166, 166, . . . are arrayed approximately in a matrix-like pattern composed of “m” number of rows and “n” number of columns (e.g., three rows and five columns).

In this embodiment, in accordance with the width of the photosensitive material 150, five exposure heads 166, 166, . . . are located along each of the first and second rows, and four exposure heads 166, 166, . . . are located along the third row. In cases where a certain exposure head 166 in the array of the exposure heads 166, 166, . . . , which exposure head is located at a position of an m'th row and an n'th column in the array of the exposure heads 166, 166, . . . , is to be represented, the certain exposure head 166 is herein represented as an exposure head 166ₘₙ.

As illustrated in FIG. 15B, an exposure processing area 168ₘₙ corresponding to each exposure head 166ₘₙ, which exposure processing area is subjected to the exposure processing performed by the exposure head 166ₘₙ, has an approximately rectangular shape, whose short side extends along the sub-scanning direction. As illustrated in FIG. 15A, as the stage 152 moves along the sub-scanning direction, a band-shaped exposure-processed region 170ₘₙ corresponding to each exposure head 166ₘₙ is formed on the photosensitive material 150.

As illustrated in FIG. 15B, in the array of the exposure heads 166, 166, . . . of the scanner unit 162, a row of the exposure heads 166, 166, . . . and an adjacent row of the exposure heads 166, 166, . . . are shifted by a predetermined distance from each other with respect to a main scanning direction, which is normal to the sub-scanning direction described above. Such that the band-shaped exposure-processed regions 170, 170, . . . may be formed on the photosensitive material 150 without any unprocessed space being left between the band-shaped exposure-processed regions 170, 170, . . . in the main scanning direction, the areas, which are located between, for example, an exposure processing area 168₁₁ and an exposure processing area 168₁₂ corresponding respectively to an exposure head 166₁₁ and an exposure head 166₁₂ located along the first row, and which are not capable of being subjected to the exposure processing performed by the exposure head 166₁₁ and the exposure head 166₁₂, are exposure-processed with an exposure head 166₂₁, which is located along the second row and corresponds to an exposure processing area 168₂₁, and an exposure head 166₃₁, which is located along the third row and corresponds to an exposure processing area 168₃₁.

Each of the exposure heads 166, 166, . . . is constituted of the light source unit 60 described above, the DMD 80 described above, the image forming optical system 50 described above, and a DMD irradiation optical system 70, which receives the light for exposure from the light source unit 60 and irradiates the light to the DMD 80. The light having been obtained from the spatial light modulation performed by the DMD 80 is guided onto the photosensitive material 150, and the photosensitive material 150 is thus exposed to the light.

### Explanation of Elements Constituting the Exposure Head 166

The elements constituting each of the exposure heads 166, 166, . . . will be described hereinbelow. The image forming optical system 50 has the constitution described above.

### Light Source Unit 60

The light source unit 60 comprises a plurality of (e.g., six) laser beam combining light sources 40, 40, . . . The light source unit 60 also comprises a laser beam radiating section 61. The laser beam radiating section 61 units a plurality of optical fibers 31, 31, . . . , each of which is connected to one of multimode optical fibers 30, 30, . . . Each of the multimode optical fibers 30, 30, . . . acts as a constituent element of one of the laser beam combining light sources 40, 40, . . .

### Explanation of the Laser Beam combining light source 40

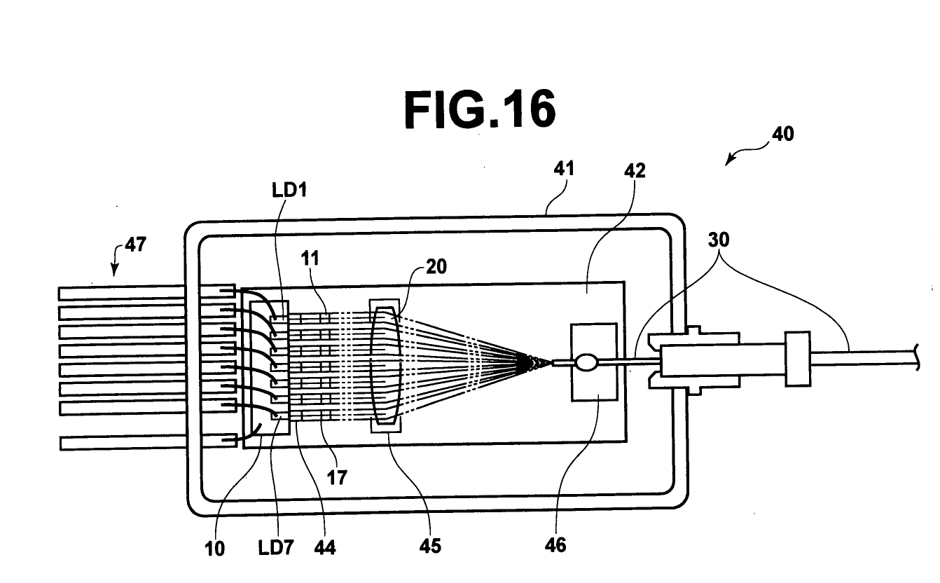

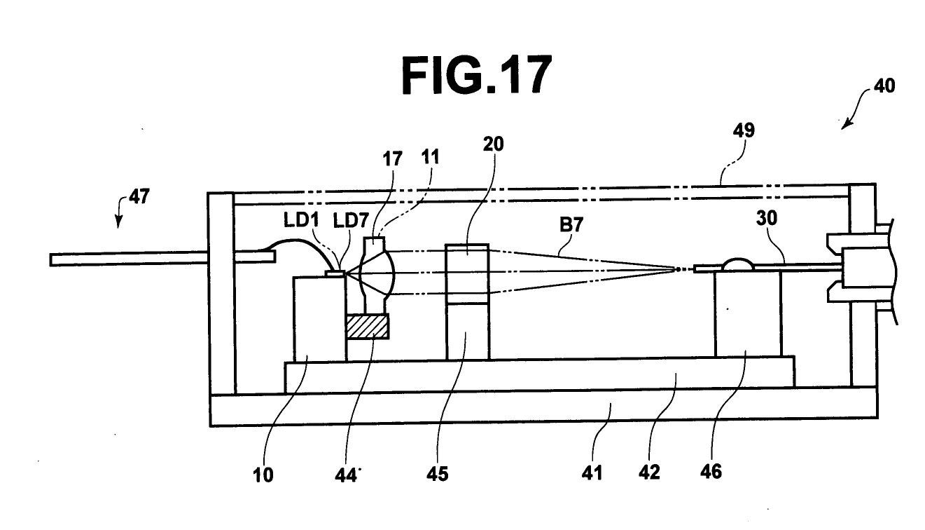

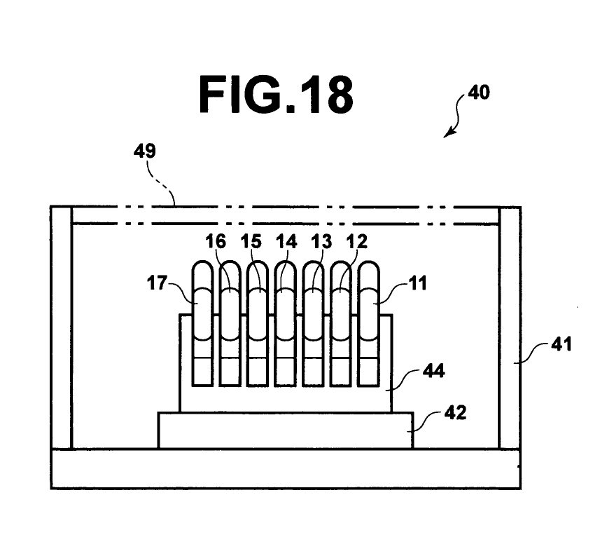

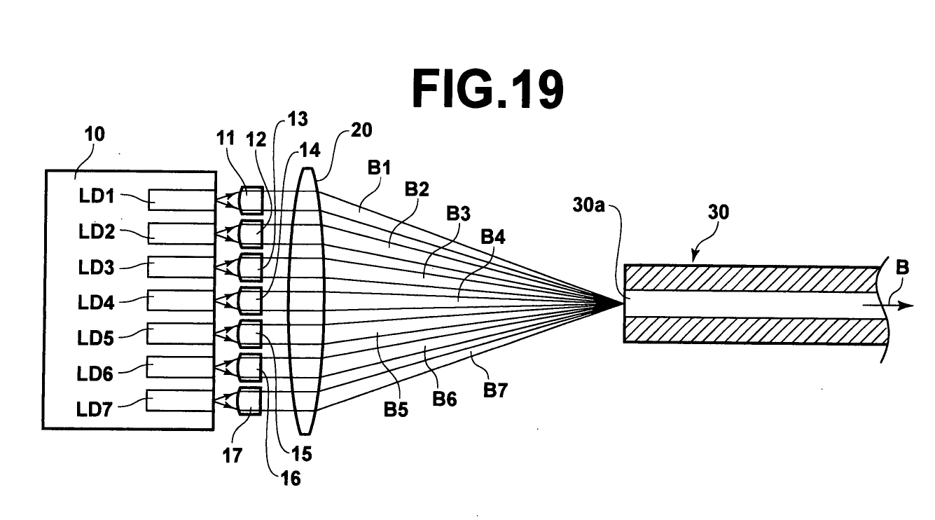

FIG. 16 is a plan view showing a laser beam combining light source. FIG. 17 is a side view showing the laser beam combining light source. FIG. 18 is a front view showing the laser beam combining light source. FIG. 19 is an enlarged plan view showing optical elements of the laser beam combining light source.

### Constitution of the Laser Beam Combining Light Source 40

Each of the laser beam combining light sources 40, 40, . . . comprises a plurality of semiconductor lasers LD1, LD2, LD3, LD4, LD5, LD6, and LD7. The laser beam combining light source 40 also comprises the one multimode optical fiber 30. The laser beam combining light source 40 further comprises a combination of collimator lenses 11 to 17 and one converging lens 20. The combination of the collimator lenses 11 to 17 and the converging lens 20 acts as laser beam converging means for converging an entire laser beam, which is composed of laser beams having been produced by the plurality of the semiconductor lasers LD1 to LD7, and irradiating the entire laser beam onto a core region of the multimode optical fiber 30. The laser beams constituting the entire laser beam are combined with one another in the multimode optical fiber 30. The combined laser beam passes through the multimode optical fiber 30 and is radiated out from the multimode optical fiber 30.

More specifically, the laser beam combining light source 40 comprises the plurality of (e.g., seven) chip-like GaN type semiconductor lasers LD1, LD2, LD3, LD4, LD5, LD6, and LD7, which may be of a transverse multimode or a single mode. The GaN type semiconductor lasers LD1, LD2, LD3, LD4, LD5, LD6, and LD7 are arrayed in one direction and secured to a top surface of a heat block 10, which is made from a material having a high heat transfer coefficient, such as copper. The laser beam combining light source 40 also comprises the collimator lenses 11, 12, 13, 14, 15, 16, and 17, which correspond respectively to the GaN type semiconductor lasers LD1, LD2, LD3, LD4, LD5, LD6, and LD7. The laser beam combining light source 40 further comprises the converging lens 20 for converging the entire laser beam, which is composed of the laser beams having been radiated out from the collimator lenses 11 to 17, into one spot. The laser beam combining light source 40 still further comprises the one multimode optical fiber 30 for receiving the entire laser beam, which has been converted by the converging lens 20, and combining the laser beams constituting the entire laser beam with one another.

The number of the semiconductor lasers LD1, LD2, . . . is not limited to seven. For example, laser beams having been produced by 20 semiconductor lasers may be irradiated to a multimode optical fiber, which has a cladding layer diameter of 60 μm, a core diameter of 50 μm, and NA of 0.2.

The laser beams produced by the GaN type semiconductor lasers LD1 to LD7 may have an identical wavelength (of, e.g., 405 nm). Also, the GaN type semiconductor lasers LD1 to LD7 may have an identical maximum output power (e.g., 100 mW in the cases of multimode lasers, or 30 mW in the cases of single mode lasers). Alternatively, as the GaN type semiconductor lasers LD1 to LD7, lasers capable of producing laser beams, which have a wavelength other than 405 nm and falling within the range of 350 nm to 450 nm, may be employed.

As illustrated in FIG. 16, FIG. 17, and FIG. 18, the optical elements of the laser beam combining light source 40 are accommodated within a box-like package 41, which has an opening at the top region. The package 41 is provided with a package cover 49 capable of closing the opening of the package 41. After the box-like package 41 is subjected to deaeration processing, a sealing gas is introduced into the package 41, and the opening of the package 41 is closed by the package cover 49. In this manner, the closed space (sealed space), which is surrounded by the package 41 and the package cover 49, is hermetically sealed.

A base plate 42 is secured to an inside bottom surface of the package 41. The heat block 10 described above, a converging lens holder 45 for supporting the converging lens 20, and a fiber holder 46 for supporting an entry end section of the multimode optical fiber 30 are secured to a top surface of the base plate 42. A radiating end section of the multimode optical fiber 30 is drawn out through an aperture, which is formed through a side wall of the package 41, to the exterior of the package 41.

The temperature of the base plate 42 is adjusted by temperature adjusting means, which utilizes a fluid as a medium, a Peltier device (not shown), or the like. While the projecting exposure apparatus is being operated, the temperature of the base plate 42 is kept at a predetermined value.

A collimator lens holder 44 is secured to a side surface of the heat block 10. The collimator lenses 11 to 17 are supported by the collimator lens holder 44. Also, electric wires 47, 47, . . . for supplying actuating electric currents to the GaN type semiconductor lasers LD1 to LD7 are drawn out through an aperture, which is formed through a side wall of the package 41.

In FIG. 16 and FIG. 17, as an aid in facilitating the explanation, only the GaN type semiconductor lasers LD1 and LD7 among the plurality of the GaN type semiconductor lasers LD1 to LD7 are numbered. Also, only the collimator lenses 11 and 17 among the plurality of the collimator lenses 11 to 17 are numbered.

FIG. 18 is a front view showing the part at which the collimator lenses 11 to 17 are fitted. Each of the collimator lenses 11 to 17 is an aspherical lens and is formed in a slender shape such that a region containing the optical axis of the aspherical lens has been cut along planes parallel to the optical axis. Each of the collimator lenses 11 to 17 having the slender shape may be formed with, for example, a resin shaping process or a glass shaping process. The collimator lenses 11 to 17 are located at positions which are close to one another and which stand side by side along the array direction of light emission points of the GaN type semiconductor lasers LD1 to LD7 (i.e., the horizontal direction in FIG. 18), such that the longitudinal direction of each of the collimator lenses 11 to 17 may be normal to the array direction of the light emission points of the GaN type semiconductor lasers LD1 to LD7 (i.e., the horizontal direction in FIG. 18).

Each of the GaN type semiconductor lasers LD1 to LD7 may be provided with an active layer having a light emission width of 2 μm. The GaN type semiconductor lasers LD1 to LD7 may produce laser beams B1 to B7, respectively, in a state such that a spread angle with respect to the direction parallel to the surface of the active layer is, for example, 10°, and such that the spread angle with respect to the direction normal to the surface of the active layer is, for example, 30°.

Each of the GaN type semiconductor lasers LD1 to LD7 is located in an orientation such that the surface of the active layer may be parallel to the array direction of the light emission points of the GaN type semiconductor lasers LD1 to LD7. Specifically, the direction, which is associated with the large spread angle of each of the laser beams B1 to B7 radiated out respectively from the light emission points described above, coincides with the longitudinal direction of each of the collimator lenses 11 to 17 having the slender shape. Also, the direction, which is associated with the small spread angle of each of the laser beams B1 to B7 radiated out respectively from the light emission points described above, coincides with the lateral direction of each of the collimator lenses 11 to 17.

The length of each of the collimator lenses 11 to 17, which length is taken along the longitudinal direction of each of the collimator lenses 11 to 17, may be equal to 4.6 mm. The width of each of the collimator lenses 11 to 17, which width is taken along the lateral direction of each of the collimator lenses 11 to 17, maybe equal to 1.1 mm. Also, the length of a major axis of the elliptic beam shape of each of the laser beams B1 to B7 incident upon the collimator lenses 11 to 17, respectively, may be equal to 2.6 mm. The length of a minor axis of the elliptic beam shape of each of the laser beams B1 to B7 incident upon the collimator lenses 11 to 17, respectively, may be equal to 0.9 mm. Each of the collimator lenses 11 to 17 may be constituted such that a focal length f is equal to 3 mm, NA is equal to 0.6, and a lens array pitch is equal to 1.25 mm.

The converging lens 20 is formed in a slender shape such that a region containing the optical axis of an aspherical lens has been cut along planes parallel to the optical axis. The converging lens 20 is located in an orientation such that the longitudinal direction of the converging lens 20 coincides with the array direction of the collimator lenses 11 to 17, and such that the lateral direction of the converging lens 20 coincides with the direction normal to the array direction of the collimator lenses 11 to 17.

The converging lens 20 is constituted such that a focal length f is equal to 23 mm, and NA is equal to 0.2. The converging lens 20 may be formed with, for example, a resin shaping process or a glass shaping process.

### Operation of the Laser Beam Combining Light Source 40

Each of the laser beams B1, B2, B3, B4, B5, B6, and B7, which have been radiated out respectively from the GaN type semiconductor lasers LD1, LD2, LD3, LD4, LD5, LD6, and LD7 constituting the laser beam combining light source 40 described above, is collimated by the corresponding one of the collimator lenses 11 to 17. The laser beams B1 to B7 having thus been collimated are converged by the converging lens 20 and impinge upon the entry end face of a core section 30a of the multimode optical fiber 30.

The laser beams B1 to B7 having thus been collimated by the converging lens 20 enter into the core section 30a of the multimode optical fiber 30 and are combined into a combined laser beam B. The combined laser beam B travels through the multimode optical fiber 30 and is radiated out from a radiating end face of the multimode optical fiber 30. The combined laser beam B having thus been radiated out from the radiating end face of the multimode optical fiber 30 impinges upon an optical fiber 31 connected to the multimode optical fiber 30 as will be described later.

For example, in cases where a coupling efficiency of the laser beams B1 to B7 with the multimode optical fiber 30 is equal to 0.85, and the output power of each of the GaN type semiconductor lasers LD1 to LD7 is equal to 30 mW, the combined laser beam B is capable of being obtained with an output power of 180 mW (=30 mW×0. 85×7). The combined laser beam B obtained with the output power described above travels through the multimode optical fiber 30 to the optical fiber 31. Therefore, the output power obtained at the laser beam radiating section 61 described below, at which the six optical fibers 31, 31, . . . connected respectively to the multimode optical fibers 30, 30, . . . of the laser beam combining light sources 40 , 40, . . . are united together, becomes equal to approximately 1W (=180 mW×6).

### Laser Beam Radiating Section 61

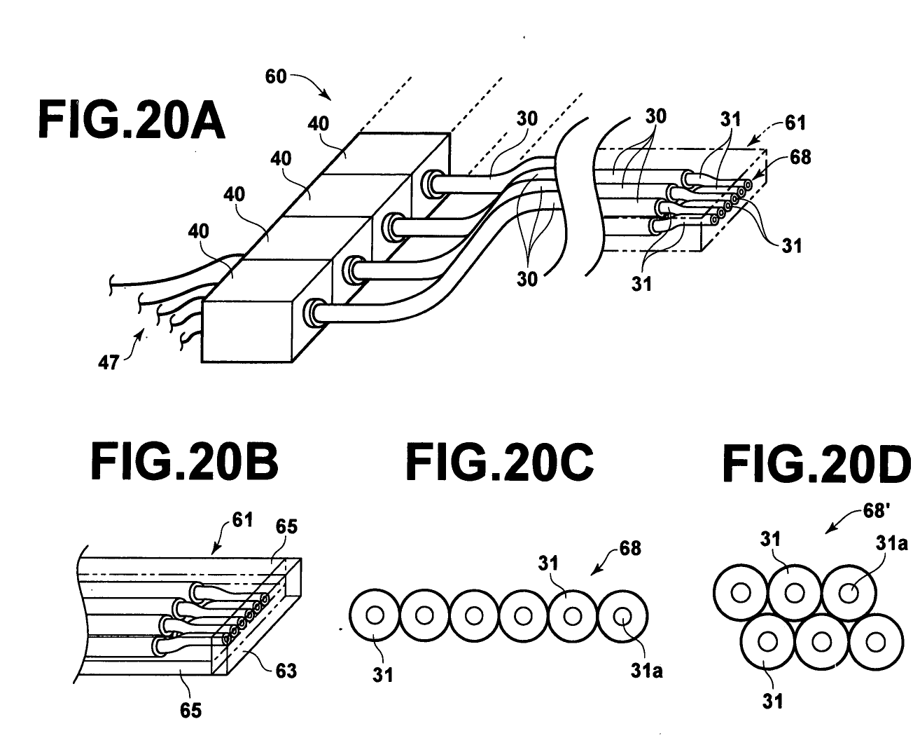

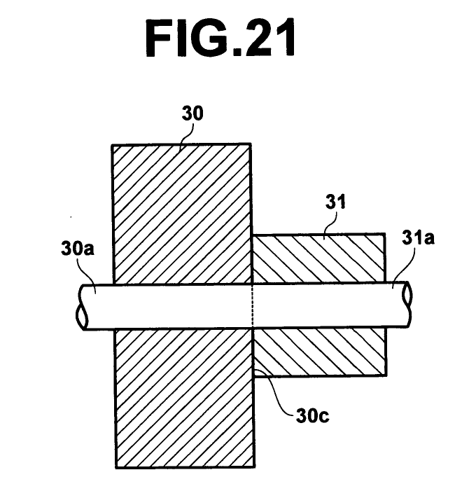

The laser beam radiating section 61 will be described hereinbelow with reference to FIG. 20A, 20B and FIG. 21. FIG. 20A is a perspective view showing how multimode optical fibers of the laser beam combining light sources are connected to optical fibers of a laser beam radiating section in a light source unit. FIG. 20B is an enlarged view showing a part of the laser beam radiating section. FIG. 20C is a front view showing an example of an array of the optical fibers at the laser beam radiating section. FIG. 20D is a front view showing a different example of an array of the optical fibers at the laser beam radiating section. FIG. 21 is a view showing how the multimode optical fiber of the laser beam combining light source and the optical fiber at the laser beam radiating section are connected to each other.

As illustrated in FIGS. 20A and 20B, the laser beam radiating section 61 described above comprises the optical fibers 31, 31, . . . , support plates 65, 65, and a protective plate 63. The laser beam radiating section 61 is constituted in the manner described below.

As illustrated in FIG. 20A, the radiating end of each of the multimode optical fibers 30, 30, . . . of the laser beam combining light sources 40, 40, . . . is connected to the entry end of the corresponding one of the optical fibers 31, 31, . . . of the laser beam radiating section 61. The entry end of each of the optical fibers 31, 31, . . . has a core diameter, which is identical with the core diameter of the multimode optical fiber 30, and a cladding layer diameter, which is smaller than the cladding layer diameter of the multimode optical fiber 30. Also, as illustrated in FIG. 20C, the radiating ends of the optical fibers 31, 31, . . . are arrayed in a row and thus constitute a radiating end section 68. Alternatively, as illustrated in FIG. 20D, the radiating ends of the optical fibers 31, 31, . . . may be stacked and arrayed in two rows and may thus constitute a radiating end section 68′.

As illustrated in FIG. 20B, the portions of the optical fibers 31, 31, . . . located on the radiating side are sandwiched between the two support plates 65, 65 having flat surfaces and are thus secured in predetermined positions. Also, the protective plate 63, which is transparent and is made from glass, or the like, for protecting the end faces of the optical fibers 31, 31, . . . on the radiating side, is located at the end faces of the optical fibers 31, 31, . . . on the radiating side. The protective plate 63 may be located such that it is in close contact with the radiating end faces of the optical fibers 31, 31, . . . Alternatively, the protective plate 63 may be located such that it is not in close contact with the radiating end faces of the optical fibers 31, 31, . . .

The connection of the optical fiber 31 and the multimode optical fiber 30 to each other may be made in the manner illustrated in FIG. 21. Specifically, the end face of the optical fiber 31 having the small cladding layer diameter is connected co-axially to a small-diameter region 30c of the end face of the multimode optical fiber 30 having the large cladding layer diameter. The connection may be performed with, for example, a fusion bonding process.

Alternatively, the connection of the optical fiber 31 and the multimode optical fiber 30 to each other may be made in the manner described below. Specifically, a short optical fiber may be prepared with a process, wherein an optical fiber having a short length and a small cladding layer diameter is fusion-bonded to an optical fiber having a short length and a large cladding layer diameter. The short optical fiber may then be connected to the radiating end of the multimode optical fiber 30 via a ferrule, an optical connector, or the like. In cases where the optical fiber 31 and the multimode optical fiber 30 are releasably connected to each other by the utilization of the connector, or the like, the optical fiber having the small cladding layer diameter is capable of being exchanged easily at the time of the breakage, or the like, and the cost required for the maintenance operations for the exposure head is capable of being kept low.

Each of the multimode optical fiber 30 and the optical fiber 31 may be a step index type optical fiber, a graded index type optical fiber, or a composite type optical fiber. For example, a step index type optical fiber, which is supplied by Mitsubishi Densen Kogyo, K.K., may be utilized as each of the multimode optical fiber 30 and the optical fiber 31. In this embodiment, each of the multimode optical fiber 30 and the optical fiber 31 is constituted of the step index type optical fiber.

The multimode optical fiber 30 is constituted such that the cladding layer diameter is equal to 125 μm, the core diameter is equal to 50 μm, NA is equal to 0.2, and the transmittance of the entry end face coating layer is equal to at least 99.5%. The optical fiber 31 is constituted such that the cladding layer diameter is equal to 60 μm, the core diameter is equal to 50 μm, and NA is equal to 0.2.

### DMD 80

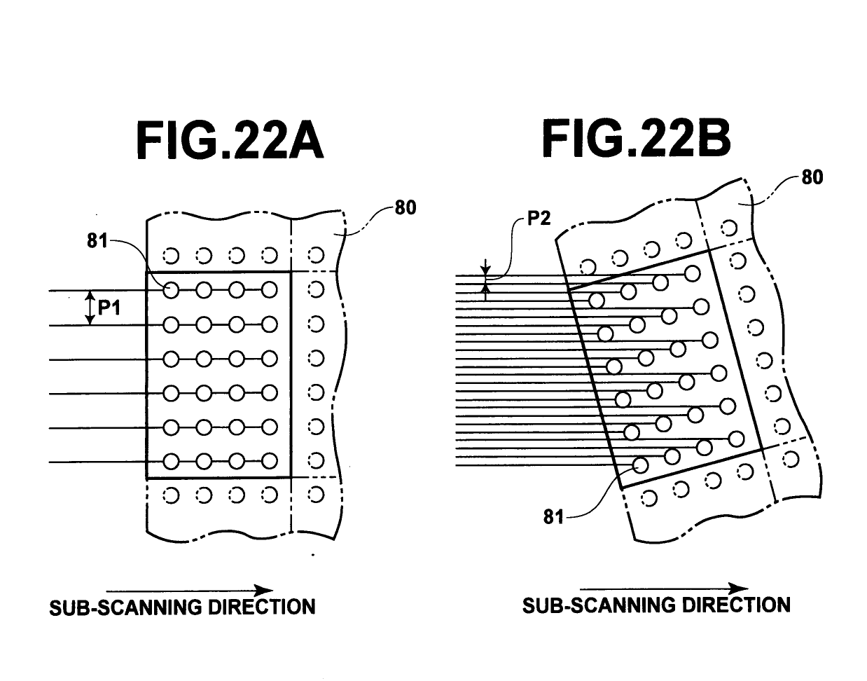

The DMD 80 will be described hereinbelow. FIG. 22A is a plan view showing how the photosensitive material is exposed to light beams in cases where the DMD is located in an orientation, which is not oblique. FIG. 22B is a plan view showing how the photosensitive material is exposed to the light beams in cases where the DMD is located in an oblique orientation.

As described above with reference to FIG. 1 and FIG. 2, each of the exposure heads 166, 166, . . . is provided with the digital micromirror device (DMD) 80 (shown in FIG. 3) acting as the spatial light modulation means for modulating the incident laser beam in accordance with a predetermined control signal. The DMD 80 is connected to a controller (not shown), which is provided with a signal processing section and a mirror actuation control section. In accordance with a received image signal, the signal processing section of the controller forms the control signal for controlling the actuation of each of the micromirrors 81, 81, . . . of the DMD 80. The control signal is formed for each of the exposure heads 166, 166, . . . Also, in accordance with the control signal having been formed by the signal processing section, the mirror actuation control section of the controller controls the angle of the reflection surface of each of the micromirrors 81, 81, . . . of the DMD 80 of each of the exposure heads 166, 166, . . .

The DMD 80 comprises an array of the micromirrors 81, 81, . . . , which array is composed of a plurality of (e.g., 1,024) columns of the micromirrors 81, 81, . . . standing side by side with respect to the longitudinal direction of the DMD 80 and a plurality of (e.g., 756) rows of the micromirrors 81, 81, . . . standing side by side with respect to the lateral direction of the DMD 80. As illustrated in FIG. 22B, in cases where the DMD 80 is located in an oblique orientation, the pitch of scanning loci (i.e., the sub-scanning lines) along the sub-scanning direction, which are formed with the laser beams having been reflected from the micromirrors 81, 81, . . . of the DMD 80, is capable of being set at a small pitch P2. The pitch P2 is smaller than a pitch P1 obtained in cases where the DMD 80 is located in an orientation, which is not oblique, as illustrated in FIG. 22A. With the setting of the inclination of the DMD 80, the resolution of exposure with the exposure head 166 is capable of being enhanced markedly.

Also, since an identical region of the photosensitive material 150 on the sub-scanning line is capable of being subjected to multiple exposure with different micromirrors 81, 81, . . . , the exposed position is capable of being controlled finely, and a high-definition exposure operation is capable of being performed. Further, joints of the two-dimensional patterns, which are formed with the exposure to the laser beams radiated out from the exposure heads 166, 166, . . . adjacent to one another with respect to the main scanning direction, are capable of being rendered imperceptible.

### DMD Irradiation Optical System 70

As illustrated in FIG. 2, the DMD irradiation optical system 70 of each of the exposure heads 166, 166, . . . comprises a collimator lens 71 for approximately collimating the plurality of the laser beams, which have been radiated out from the laser beam radiating section 61 of the light source unit 60, as a whole. The DMD irradiation optical system 70 also comprises a micro fry-eye lens 72, which is located in the optical path of the light having passed through the collimator lens 71. The DMD irradiation optical system 70 further comprises a micro fry-eye lens 73, which is located so as to stand facing the micro fry-eye lens 72. The DMD irradiation optical system 70 still further comprises a field lens 74, which is located on the radiating side of the micro fry-eye lens 73, i.e. on the side facing the mirror 75 described later. The DMD irradiation optical system 70 also comprises the prism 76.

Each of the micro fry-eye lens 72 and the micro fry-eye lens 73 comprises a plurality of fine lens cells, which are arrayed in two-dimensional directions. The laser beams having passed through the fine lens cells impinge in an overlapping state upon the DMD 80 via the mirror 75 and the prism 76. Therefore, the distribution of the intensities of the laser beams impinging upon the DMD 80 is capable of being rendered uniform.

The mirror 75 reflects the laser beams having passed through the field lens 74. Also, the prism 76 is the TIR prism (the total reflection prism) and totally reflects the laser beams, which have been reflected from the mirror 75, toward the DMD 80. In the manner described above, the DMD irradiation optical system 70 irradiates the laser beams, which have the approximately uniform intensity distribution, onto the DMD 80.

### Explanation of the Operation of the Projecting Exposure Apparatus

How the aforesaid projecting exposure apparatus operates will be described hereinbelow.

The projecting exposure apparatus is actuated, and the respective sections of the projecting exposure apparatus are set in an operating state. In this state, the temperature of the laser beam combining light sources 40, 40, . . . of each of the exposure heads 166, 166, . . . is adjusted. However, the GaN type semiconductor lasers LD1 to LD7 of each of the laser beam combining light sources 40, 40, . . . are not turned on.

The image signal corresponding to the two-dimensional pattern is fed into the controller (not shown), which is connected to the DMD 80 of each of the exposure heads 166, 166, . . . The image signal is stored in a frame memory of the controller. The image signal represents the image densities of the pixels constituting the image. By way of example, the image signal may represent the image density of each pixel by the binary notation (representing whether a dot is to be or is not to be recorded).

The stage 152 having the surface, on which the photosensitive material 150 has been supported by suction, is moved by the actuating section (not shown) at a predetermined speed from the side more upstream than the scanner support section 160 to the side more downstream than the scanner support section 160 along the guides 158, 158 and under the scanner support section 160. At the time at which the stage 152 passes under the scanner support section 160, the leading end of the photosensitive material 150 is detected by the detection sensors 164, 164, which are secured to the scanner support section 160. After the leading end of the photosensitive material 150 has been detected by the detection sensors 164, 164, the image signal components of the image signal, which has been stored in the frame memory of the controller, are successively read from the frame memory in units of a plurality of scanning lines. In accordance with the thus read image signal components of the image signal, the signal processing section forms the control signal for each of the exposure heads 166, 166, . . .

When preparations for the exposure operation on the photosensitive material 150 has been made, the GaN type semiconductor lasers LD1 to LD7 of each of the laser beam combining light sources 40, 40, . . . of each of the exposure heads 166, 166, . . . are turned on. In accordance with the control signal having been formed by the signal processing section, each of the micromirrors 81; 81, . . . of the DMD 80 of each of the exposure heads 166, 166, . . . is controlled by the mirror actuation control section of the controller. The photosensitive material 150 is thus exposed to the laser beams.

When the laser beams, which have been produced by the laser beam combining light sources 40, 40, . . . and have been radiated out from the laser beam radiating section 61, are irradiated to the DMD 80 via the DMD irradiation optical system 70 in each of the exposure heads 166, 166, . . . , the laser beams are reflected from the micromirrors 81, 81, . . . of the DMD 80, which micromirrors are in the on state. The thus reflected laser beams pass through the image forming optical system 50, and the images of the laser beams are formed on the photosensitive surface 151 of the photosensitive material 150. The images of the laser beams reflected from the micromirrors 81, 81, . . . of the DMD 80, which micromirrors are in the off state, are not formed on the photosensitive surface 151. Therefore, the photosensitive material 150 is not exposed to the laser beams reflected from the micromirrors 81, 81, . . . of the DMD 80, which micromirrors are in the off state.

In the manner described above, the laser beams, which have been radiated out from the light source unit 60 of each of the exposure beads 166, 166, . . . , are on-off modulated for each of the micromirrors 81, 81, . . . of the DMD 80 (i.e., for each of the pixels). As illustrated in FIG. 14 and FIGS. 15A, 15B, each of the exposure processing areas 168, 168, . . . on the photosensitive material 150 is subjected to the exposure processing performed by one of the exposure heads 166, 166, . . . Also, the photosensitive material 150 is moved in the sub-scanning direction together with the stage 152, and each of the band-shaped exposure-processed regions 170, 170, . . . extending in the sub-scanning direction is formed by one of the exposure heads 166, 166, . . .

### Use of Part of the DMD 80)

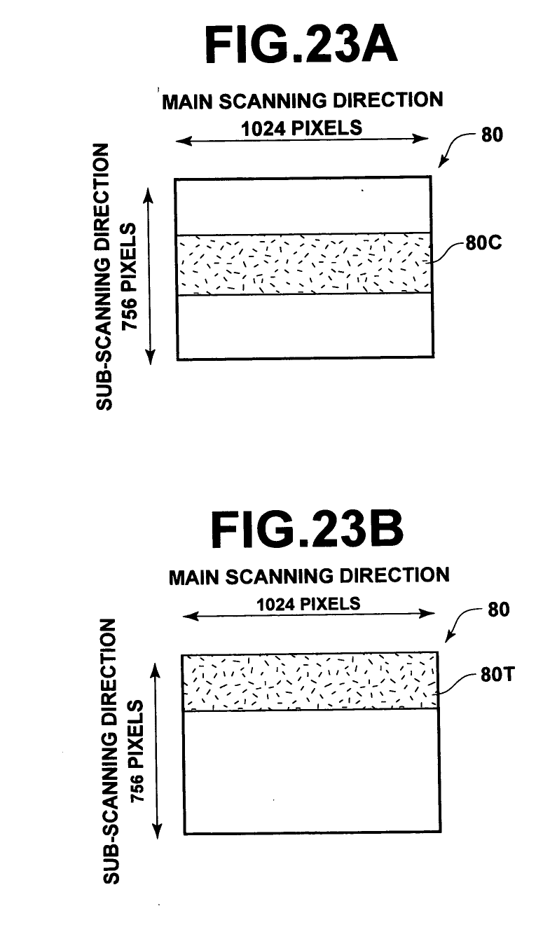

In this embodiment, as illustrated in FIGS. 23A and 23B, the DMD 80 comprises the array of the micromirrors 81, 81, . . . , which array is composed of the plurality of (e.g., 1,024) columns (pixels) of the micromirrors 81, 81, . . . standing side by side with respect to the longitudinal direction of the DMD 80 (corresponding to the main scanning direction in the exposure operation) and a plurality of (e.g., 756) rows (pixels) of the micromirrors 81, 81, . . . standing side by side with respect to the lateral direction of the DMD 80 (corresponding to the sub-scanning direction in the exposure operation). However, in this embodiment, the controller controls such that only certain rows of the micromirrors 81, 81, . . . (e.g., 1,024 micromirrors×300 rows) are actuated.

For example, as illustrated in FIG. 23A, only the micromirrors 81, 81, . . . located in an array region 80C of the DMD 80, which array region is constituted of certain middle rows, may be actuated. Alternatively, as illustrated in FIG. 23B, only the micromirrors 81, 81, . . . located in an array region 80T of the DMD 80, which array region is constituted of certain rows at an end area, maybe actuated. Also, in cases where a failure occurs with a certain micromirror 81, the micromirrors 81, 81, . . . located in an array region other than the array region containing the defective micromirror 81 may be utilized. In this manner, the array region of the DMD 80 to be used maybe altered in accordance with the condition of the operation.

Specifically, limitation is imposed upon the signal processing speed for the DMD 80, and the modulation speed per scanning line is determined in proportion to the number of the micromirrors 81, 81, . . . to be controlled (i.e., the number of the pixels). Therefore, in cases where only the micromirrors 81, 81, . . . located within a certain part of the array region of the DMD 80 are used, the modulation speed per scanning line is capable of being kept high.

When the exposure operation performed in accordance with the image signal having been stored in the frame memory of the controller connected to the DMD 80 is finished, the GaN type semiconductor lasers LD1 to LD7 are turned off, and the radiating of the laser beams from the laser beam combining light sources 40, 40, . . . is ceased. Thereafter, the scanning operation performed by the scanner unit 162 for the photosensitive material 150 in the sub-scanning direction is finished, and the tail end of the photosensitive material 150 is detected by the detection sensors 164, 164. When the tail end of the photosensitive material 150 has thus been detected by the detection sensors 164, 164, the stage 152 is returned by the actuating section (not shown) along the guides 158, 158 to the original position, which is located at the most upstream side with respect to the scanner support section 160. In cases where the next exposure operation is to be performed, the stage 152 is again moved along the guides 158, 158 from the side more upstream than the scanner support section 160 to the side more downstream than the scanner support section 160.

The projecting exposure apparatus in accordance with the present invention is not limited to the cases where the DMD 80 is employed as the spatial light modulation means. The projecting exposure apparatus in accordance with the present invention may be constituted such that an exposure mask 80R comprising a glass plate, on which a two-dimensional pattern has been drawn, or the like, is employed in lieu of the DMD 80. In such cases, as in the embodiment described above, the distortion occurring at the time of the projection of the two-dimensional pattern of light is capable of being kept small, and the MTF performance is capable of being enhanced. Also, the effects of enhancing the efficiency with which the light having been produced by the light source is utilized is capable of being enhanced.

Further, with the projecting exposure apparatus in accordance with the present invention, no limitation is imposed upon the wavelengths of the light used for the exposure operation, and the exposure operation with light having wavelengths falling within various wavelength regions is capable of being performed. Furthermore, no limitation is imposed upon the technique for irradiating the light to the spatial light modulation means, the kind of the light source, or the like.

What is claimed is:

1. A projecting exposure apparatus, comprising:
i) an exposure mask for performing modulation of light, which has been produced by a light source, and
ii) an image-side telecentric image forming optical system for forming an image of a two-dimensional pattern of the light, which has been obtained from the modulation performed by the exposure mask, on a photosensitive material, the two-dimensional pattern of the light being projected through the image forming optical system onto the photosensitive material, the photosensitive material being thus exposed to the two-dimensional pattern of the light,
wherein at least either one of two pupil-adjacent lenses, which are adjacent to each other with an entrance pupil position in the image forming optical system intervening between the two pupil-adjacent lenses, is constituted such that at least either one of lens surfaces of the pupil-adjacent lens is an aspherical surface.

2. An apparatus as defined in claim 1 wherein at least either one of the two pupil-adjacent lenses is constituted such that the lens surface of the pupil-adjacent lens, which lens surface is opposite to the other lens surface located on the side of the entrance pupil position, is the aspherical surface.

3. An apparatus as defined in claim 1 wherein at least either one of the two pupil-adjacent lenses is constituted such that both the lens surfaces of the pupil-adjacent lens are the aspherical surfaces.

4. An apparatus as defined in claim 3 wherein a first pupil-adjacent lens, which is one of the two pupil-adjacent lenses and is located on the side opposite to the side of the photosensitive material, is constituted such that an absolute value of a coefficient representing a conic component of a configuration of an incidence-side lens surface of the first pupil-adjacent lens is larger than the absolute value of the coefficient representing the conic component the configuration of a radiating-side lens surface of the first pupil-adjacent lens.

5. An apparatus as defined in claim 3 wherein a second pupil-adjacent lens, which is one of the two pupil-adjacent lenses and is located on the side of the photosensitive material, is constituted such that an absolute value of a coefficient representing a conic component of a configuration of an incidence-side lens surface of the second pupil-adjacent lens is smaller than the absolute value of the coefficient representing the conic component of the configuration of a radiating-side lens surface of the second pupil-adjacent lens.

6. An apparatus as defined in claim 4 wherein the first pupil-adjacent lens is constituted such that a ratio δo=δ1/δ2 of a value δ1, which is the absolute value of the coefficient representing the conic component of the configuration of the incidence-side lens surface of the first pupil-adjacent lens, to a value δ2,
which is the absolute value of the coefficient representing the conic component of the configuration of the radiating-side lens surface of the first pupil-adjacent lens, satisfies a condition 1<δo<70.

7. An apparatus as defined in claim 5 wherein the second pupil-adjacent lens is constituted such that a ratio γo=γ1/γ2 of a value γ1, which is the absolute value of the coefficient representing the conic component of the configuration of the radiating-side lens surface of the second pupil-adjacent lens, to a value γ2,
which is the absolute value of the coefficient representing the conic component of the configuration of the incidence-side lens surface of the second pupil-adjacent lens, satisfies a condition 1<γo<70.

8. An apparatus as defined in claim 1 wherein the light, which passes through the image forming optical system, has a wavelength falling within the range of 350 nm to 450 nm.

9. An apparatus as defined in claim 2 wherein the light, which passes through the image forming optical system, has a wavelength falling within the range of 350 nm to 450 nm.

10. An apparatus as defined in claim 3 wherein the light, which passes through the image forming optical system, has a wavelength falling within the range of 350 nm to 450 nm.
